(19) United States
(12) Patent Application Publication
(10) Pub. No.: US 2022/0199077 A1
(43) Pub. Date: Jun. 23, 2022

(54) INFORMATION PROCESSING APPARATUS, MOBILE OBJECT, COMPUTER-READABLE RECORDING MEDIUM, AND INFORMATION PROCESSING METHOD

(71) Applicant: HONDA MOTOR CO.,LTD., Tokyo (JP)

(72) Inventors: Yuto KOJIMA, Tokyo (JP); Kosei TSUSHIMA, Tokyo (JP); Shohei TSUKAHARA, Tokyo (JP); Takahiro OTSUKA, Tokyo (JP)

(21) Appl. No.: 17/453,861

(22) Filed: Nov. 8, 2021

(30) Foreign Application Priority Data
Dec. 18, 2020 (JP) 2020-210642

(51) Int. Cl. G10L 15/22; G10L 15/32

(52) U.S. Cl. CPC G10L 15/22; G10L 2015/223; G10L 15/32

(57) ABSTRACT

In an information processing apparatus configured to utilize a first speech recognition function provided by an external speech recognizer via a communication network to execute a speech recognition processing, a processor is configured to detect trigger information, which shows that a user wishes to start the speech recognition processing, predict a future communication state, and inform the user of a state of the speech recognition processing based on the predicted future communication state when the trigger information is detected.

The contents of the following Japanese patent application are incorporated herein by reference:
NO. 2020-210642 filed in JP on Dec. 18, 2020.

### BACKGROUND

### 1. Technical Field

The present invention relates to an information processing apparatus, a mobile object, a computer-readable recording medium, and an information processing method.

### 2. Related Art

Patent document 1 discloses that when communication has become impossible during interaction, the timing of the return of communication is estimated, and according to the waiting time until the return, information to be presented to the user is altered. Patent document 2 discloses that even when communication has become impossible, the recognition result which corresponds to the input speech from among recognition results which have been accumulated and recognized by means of the speech recognition server in the past is acquired. Patent document 3 discloses that when the speech recognition result cannot be received from the server, the recognition engine is utilized for the speech of the local terminal.

### PRIOR ART DOCUMENTS

### Patent Document

[Patent Document 1] Japanese patent application publication No. 2014-174485
[Patent Document 2] Japanese patent application publication No. 2014-115936
[Patent Document 3] Japanese patent application publication No. 2006-003686

### BRIEF DESCRIPTION OF THE DRAWINGS

FIG. 1 schematically shows the utilization form of a vehicle 50 according to an embodiment.

FIG. 2 schematically shows the functional configuration of the vehicle 50.

FIG. 3 is a table showing priority levels of data communications.

FIG. 4 shows an example of the data structure of data communication information that the information processing apparatus 200 stores.

FIG. 5 conceptually shows the control of the communication throughput that a communication control unit 230 performs on the basis of a priority level.

FIG. 6 schematically shows the flow of data between functional blocks of the information processing apparatus 200.

FIG. 7 shows a flowchart related to the information processing method that the information processing apparatus 200 executes.

FIG. 8 shows a flowchart related to the control method of the communication throughput that the information processing apparatus 200 executes.

FIG. 9 shows an example implementation of the control system 1000 in the vehicle 50.

FIG. 10 schematically shows an example of the internal configuration of an information system device 1041.

FIG. 11 schematically shows an example of the internal configuration of a speech recognition control unit 276.

FIG. 12 schematically shows an example of the internal configuration of a speech recognition system 1074.

FIG. 13 schematically shows an example of the information processing by the vehicle 50.

FIG. 14 schematically shows an example of the information processing by the vehicle 50.

FIG. 15 shows an example of a computer 3000.

### DESCRIPTION OF EXEMPLARY EMBODIMENTS

Hereinafter, the present invention will be described through embodiments, but the following embodiments do not limit the invention according to the claims. In addition, not all of the combinations of features described in the embodiments are essential to the solution of the invention.

[Outline of Vehicle 50]

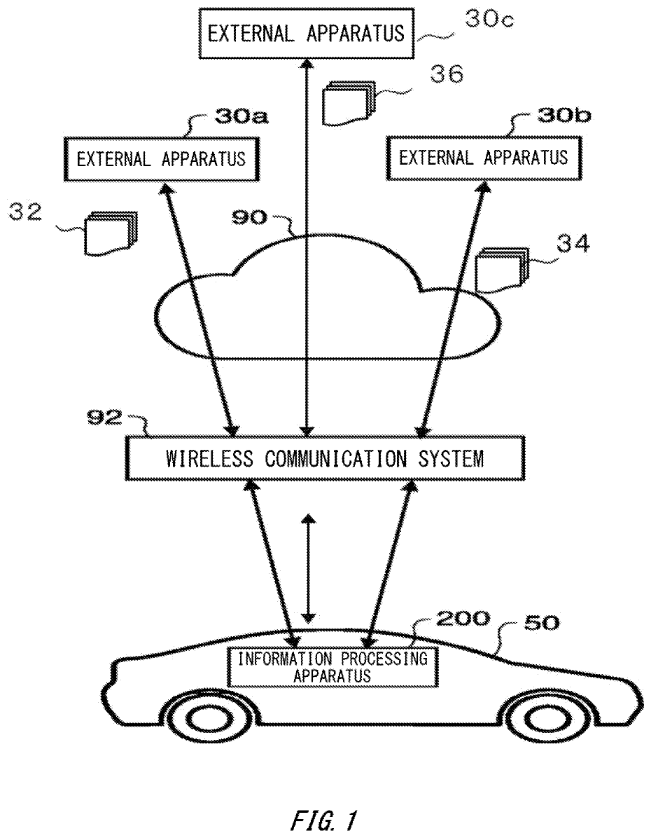

FIG. 1 schematically shows the utilization form of a vehicle 50 according to an embodiment. The vehicle 50 is a motor vehicle, for example. The vehicle 50 may be an example of a transport device, which transports people or items. Examples of the vehicle 50 include a motor vehicle, a two-wheeled motor vehicle, a vehicle for standing ride having a power unit, a train, a working machine, and the like. Examples of the motor vehicle include a motor vehicle comprising an internal combustion engine, an electric vehicle, a fuel-cell vehicle (FCV), a hybrid car, a small commuter, an electronic cart, and a bus. Examples of the two-wheeled motor vehicle include a motorcycle, a three-wheeled motor bike, and an electric bicycle. Examples of the train include various vehicles utilized for track-based transportation systems, such as a railway, a tram, LRT (Light Rail Transit), and a monorail. Examples of the working machine include a heavy machine and an agricultural machine. Examples of the agricultural machine include agricultural machinery, a lawn mower, and a weed cutter. Also, a use for the vehicle 50 is not particularly limited. The use of the vehicle 50 may be for private use, may be for business use, or may be for public transportation use.

The vehicle 50 comprises an information processing apparatus 200. The information processing apparatus 200 performs data communication with an external apparatus 30a and an external apparatus 30b. In the present embodiment, the information processing apparatus 200 transmits and receives information to/from the external apparatus 30a, the external apparatus 30b and an external apparatus 30c through a communication network 90 and a wireless communication system 92. For example, the information processing apparatus 200 transmits and receives data 32 to/from the external apparatus 30a. For example, the information processing apparatus 200 transmits and receives data 34 to/from the external apparatus 30b. For example, the information processing apparatus 200 transmits and receives data 36 to/from the external apparatus 30c. Note that in the present embodiment, the external apparatus 30a, the external apparatus 30b and the external apparatus 30c may be collectively referred to as the external apparatus 30.

The external apparatus 30a includes a server which provides services to the occupant of the vehicle 50, for example. For example, the external apparatus 30a includes a server which stores content data, such as a video, and a server which provides the SNS (social network service). The information processing apparatus 200 receives video data from the external apparatus 30a in accordance with an instruction by the occupant of the vehicle 50. The information processing apparatus 200 also receives text information, speech information, image information, video information and the like as SNS messages from the external apparatus 30a in accordance with the instruction of the occupant of the vehicle 50. The information processing apparatus 200 also transmits text information, speech information, image information, video information and the like as the SNS messages from the occupant of the vehicle 50 to the external apparatus 30a in accordance with the instruction of the occupant of the vehicle 50.

In another embodiment, the external apparatus 30a may provide an online drive recorder service. For example, the external apparatus 30a receives, from the vehicle 50, image data which has been captured by an image-capturing device (not depicted) disposed in the vehicle 50 and stores the data in any storage apparatus (not depicted). The above-described image may be a still image or may be a moving image. The external apparatus 30a may receive speech data from the vehicle 50, where the sounds are collected by a speech input device (not depicted) which is disposed in the vehicle 50 and may store the data in any storage apparatus (not depicted). The external apparatus 30a may also extract the image or speech data stored in the above-described storage apparatus in accordance with the instruction of the occupant of the vehicle 50 and transmit the extracted data to the vehicle 50.

The external apparatus 30b is a server which provides a service related to the control system of the vehicle 50, for example. The external apparatus 30b may include a server which collects control-system-related information of the vehicle 50. Examples of the control-related information that the external apparatus 30 collects can include LIDAR data or the like used for the automated drive of the vehicle 50. The external apparatus 30b may include a server which provides the vehicle 50 with the control-system-related information. The control-system-related information provided by the external apparatus 30b may include a map data used for the automated drive of the vehicle 50. The information processing apparatus 200 transmits the LIDAR data acquired for controlling the automated drive or the like to the external apparatus 30b. The information processing apparatus 200 receives the map data from the external apparatus 30b regardless of the instruction of the occupant of the vehicle 50.

The external apparatus 30c provides a speech recognition function via the communication network 90. For example, the information processing apparatus 200 transmits the speech data of the user to the external apparatus 30c. The external apparatus 30c analyzes the speech data of the user and estimates the content of the command or order instructed by the user. The external apparatus 30c transmits the information showing the contents of the command or order to the information processing apparatus 200. In this manner, the speech recognition function is provided via the communication network 90. Examples of the data 36 include the speech data of the user which is transmitted from the vehicle 50 to the external apparatus 30c and the data showing the speech recognition result by the external apparatus 30c.

In the present embodiment, the communication network 90 includes an IP network of the Internet or the like, P2P network, private line including VPN, and virtual network. In the present embodiment, the wireless communication system 92 is a mobile communication network connected to the communication network 90. For example, the wireless communication system 92 includes a radio access network and a core network.

In the present embodiment, the information processing apparatus 200 controls the communication throughput for communicating with the external apparatus 30 in accordance with the priority level of the data communication. For example, the data communication of SNS data or the like has a lower priority than the data communication of control-system-related information of the vehicle 50. For example, the data communication of the data for the information processing apparatus 200 to execute the speech recognition processing by utilizing the external apparatus 30c has a lower priority than the data communication of the control-system-related information of the vehicle 50.

In the present embodiment, the information processing apparatus 200 predicts a future communication state on the basis of time series data of a communication state in the past. For example, the information processing apparatus 200 predicts a future communication throughput on the basis of the time series data of the communication throughput in the past. If the future communication throughput is predicted to be low, the information processing apparatus 200 delays the data communication with the external apparatus 30a having a lower priority than the control-related information of the vehicle 50 to such an extent that the minimum quality of service can be maintained. In this manner, the communication throughput of the data communication of the control-related information of vehicle 50 is maintained.

If the communication throughput is predicted to be still lower, and the minimum quality of service in communication with the external apparatus 30a is predicted to be impossible to be maintained, the information processing apparatus 200 stops the data communication with the external apparatus 30a to maintain the communication throughput of data communication of the control-system-related information of the vehicle 50. In this manner, the information processing apparatus 200 can increase the possibility that the data communication having a higher priority level can be continued by restricting the communication of the data having a lower priority level.

As mentioned above, according to the present embodiment, the information processing apparatus 200 gives a higher priority on the data communication of the data 34, which includes the control-system-related information of the vehicle 50, than the data communication of the data 32, which includes (i) the content data of the video, music, speech, and game and (ii) the SNS data including SNS messages. Therefore, when the passenger (who may be referred to as the user) of a transport device or a mobile object, such as the vehicle 50, utilizes a service that is provided by sending and receiving the data 32, data damage or communication delay can occur due to the change in the communication state. As a result, for example, there is a possibility that the quality of service provided by the external apparatus 30a is greatly deteriorated, or the suspending and resuming of providing a service are repeated.

As mentioned above, according to the present embodiment, the information processing apparatus 200 gives a higher priority on the data communication of the data 34, which includes the control-system-related information of the vehicle 50, than the data communication of the data 36. Therefore, due to the change in the communication state, the information processing apparatus 200 may not be able to execute the speech recognition processing by utilizing the external apparatus 30c. Also, due to the change in the communication state, when the information processing apparatus 200 has executed the speech recognition processing utilizing the external apparatus 30c, the time until the information processing apparatus 200 responds to the user may become longer. Therefore, it is desired that technology for preventing a significant deterioration in usability even when there is a change in the communication state while the vehicle 50 moves is developed.

Therefore, in the present embodiment, when executing the speech recognition processing by utilizing the speech recognition function provided by the external apparatus 30c via the communication network, the information processing apparatus 200 informs the user of the state of the speech recognition processing. Specifically, first, the information processing apparatus 200 detects trigger information, which shows that the user wishes to start the speech recognition processing. Examples of the trigger information include a Wake-Up keyword being uttered, a starting button of the speech recognition processing being pushed, and an icon in which a start command of the speech recognition processing is embedded being selected.

Next, the information processing apparatus 200 predicts the future communication state. The information processing apparatus 200 also decides the state of the speech recognition processing at a certain time in the future on the basis of the predicted future communication state. The information processing apparatus 200 informs the user of the decided state of the speech recognition processing. Examples of the state of the speech recognition processing include (i) a state where the speech recognition processing can be executed by utilizing the speech recognition function provided by the external apparatus 30c, (ii) a state where the speech recognition processing cannot be executed by utilizing the speech recognition function provided by the external apparatus 30c, (iii) a state where the time for executing the speech recognition processing becomes longer when utilizing the speech recognition function provided by the external apparatus 30c. Note that informing the user of the state of the speech recognition processing may include not only actually informing the user of the state of the speech recognition processing but also deciding to inform the user of the state of the speech recognition processing.

According to the present embodiment, the user can be informed of the shift in the state of the speech recognition processing due to the change in the communication state in advance. In this manner, in accordance with the state of the speech recognition processing, the user can (i) input the command or order without utilizing the speech recognition processing by the information processing apparatus 200, (ii) alter the contents of the utterance so that the command or order can be input by utilizing the speech recognition processing by information processing apparatus 200 without utilizing the speech recognition function provided by the external apparatus 30c, or (iii) postpone the time of inputting the command or order. As a result, even when the communication state changes, the significant deterioration in usability can be prevented.

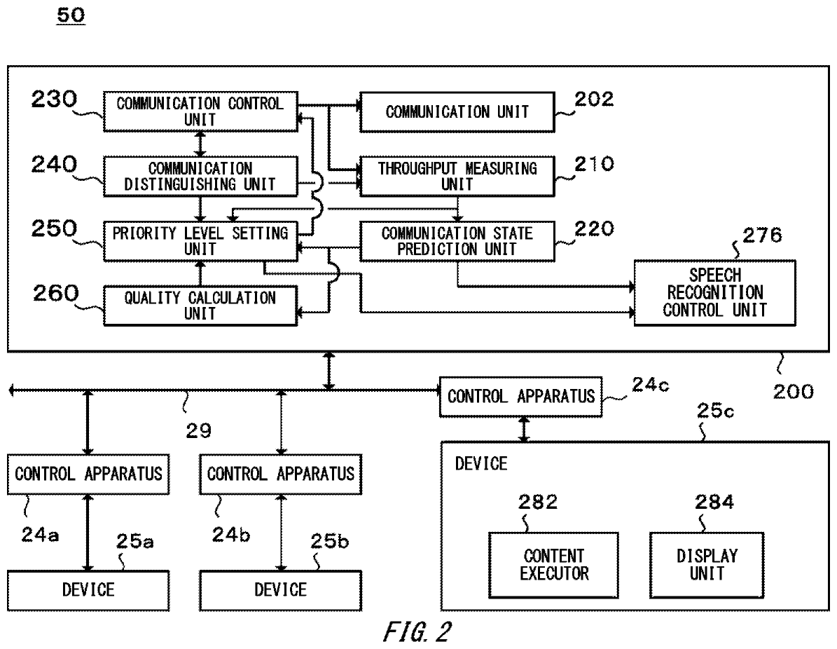

Note that, for example, when the current communication state is not good, the future communication state may not be able to be predicted by the information processing apparatus 200. Examples of the current communication state include the current throughput, delay, and packet loss. The current communication state, for example, is measured by the throughput measuring unit 210, which is described in FIG. 2.

Therefore, in the above-described embodiment, when the information processing apparatus 200 was able to predict the future communication state, the information processing apparatus 200 may (i) decide the state of the speech recognition processing at a certain time in the future on the basis of said predicted future communication state and (ii) inform the user of the decided state of the speech recognition processing. On the other hand, when the information processing apparatus 200 was not able to predict the future communication state, the information processing apparatus 200 may inform the user of the fact that the future communication state could not be predicted and/or the current communication state. In this manner, regardless of whether the information processing apparatus 200 was able to predict the future communication state, the user is informed of information.

[Specific Configuration of Each Unit of Information Processing Apparatus 200]

Each unit of the information processing apparatus 200 may be achieved by hardware, may be achieved by software, or may be achieved by hardware and software. At least a part of each unit of the information processing apparatus 200 may be achieved by a single server or may be achieved by a plurality of servers. At least a part of each unit of the information processing apparatus 200 may be achieved on a virtual machine or on a cloud system. At least a part of each unit of the information processing apparatus 200 may be achieved by a personal computer or a mobile terminal. Examples of the mobile terminal can include a mobile phone, a smartphone, a PDA, a tablet, a notebook computer or laptop computer, and a wearable computer. Each unit of the information processing apparatus 200 may store information utilizing distributed ledger technology, such as a blockchain, or distributed network. The details of the information processing apparatus 200 will be described below.

The external apparatus 30c may be an example of an external speech recognizer. The speech recognition function provided by the external apparatus 30c may be an example of a first speech recognition function. The vehicle 50 may be an example of the mobile object.

[Example of Another Embodiment]

In the present embodiment, a case where the information processing apparatus 200 is equipped in the vehicle 50, which is an example of the transport device or the mobile object, is used as an example to describe the details of the information processing apparatus 200. However, the transport device or the mobile object in which the information processing apparatus 200 is equipped is not limited to the present embodiment. Other examples of the transport device or the mobile object include a flight vehicle which moves in the air, and a marine vessel that moves on the water or underwater. Examples of the flight vehicle include an airplane, an air ship or a balloon, a hot-air balloon, a helicopter, and a drone. Examples of the marine vessel include a ship, a hovercraft, a water bike, a submarine ship, a submarine boat, and a water scooter.

In the present embodiment, a case where the information processing apparatus 200 predicts the future communication state on the basis of the time series data of the past communication state is used as an example to describe the details of an example of the information processing apparatus 200. However, the method in which the information processing apparatus 200 predicts the future communication state is not limited to the present embodiment.

In another embodiment, the information processing apparatus 200 predicts the future communication state on the basis of (i) information related to the communication state acquired by another vehicle that has driven ahead and (ii) big data constructed on the basis of information related to the communication state acquired by a plurality of vehicles. The information related to the communication state acquired by another vehicle that has driven ahead, and the above-described big data may be stored in the external apparatus 30.

The information processing apparatus 200 may acquire, from the external apparatus 30, information related to the communication state related to a certain location on the driving route of the vehicle 50 in which the information processing apparatus 200 is equipped. The information processing apparatus 200 may acquire information related to the communication state that said vehicle has acquired from another vehicle that has driven ahead by way of vehicle-to-vehicle communication.

In yet another embodiment, the external apparatus 30 may estimate the future communication state related to a certain location on the driving route of the vehicle 50 in which the information processing apparatus 200 is equipped. In this case, the information processing apparatus 200 may acquire the information showing the estimated value of the future communication state on the driving route of the vehicle 50 from the external apparatus 30.

More specifically, the information processing apparatus 200 may predict the future communication state by using various information showing the geographic distribution of the communication state (which may be referred to as map information). The information processing apparatus 200 acquires various information showing the geographic distribution of the communication state from the external apparatus 30, for example.

The information processing apparatus 200 may predict the future communication state by utilizing the map information showing each location of one or more areas with a high possibility of having poor communication state in advance. For each of the one or more areas, the map information may associate the information showing the location of the area with the information showing the communication state at said location or in said area and store them.

In an embodiment, the information processing apparatus 200 acquires the information showing the self-location of the vehicle 50 from the self-location estimating apparatus (not depicted) disposed in the vehicle 50 or the information processing apparatus 200. The information processing apparatus 200 predicts the future location or area of the vehicle 50 on the basis of the movement history of the vehicle 50 which is shown by the information showing the self-location of the vehicle 50. By comparing the above-described prediction result and the above-described map information, the information processing apparatus 200 can predict the future communication state.

In another embodiment, the information processing apparatus 200 acquires the information showing a movement path of the vehicle 50 from a path exploration apparatus (not depicted) disposed in the vehicle 50 or the information processing apparatus 200. The information processing apparatus 200 also acquires the information showing the self-location of the vehicle 50 from the self-location estimating apparatus (not depicted) disposed in the vehicle 50 or the information processing apparatus 200. The information processing apparatus 200 predicts the future location or area of the vehicle 50 on the basis of the information showing the self-location of the vehicle 50 and the information showing the movement path of the vehicle 50. By comparing the above-described prediction result and the above-described map information, the information processing apparatus 200 can predict the future communication state.

FIG. 2 schematically shows the functional configuration of the vehicle 50. In the present embodiment, the vehicle 50, for example, comprises the information processing apparatus 200, a control apparatus 24a, a control apparatus 24b, a control apparatus 24c, a device 25a, a device 25b, a device 25c, and an in-vehicle network 29. In the present embodiment, the information processing apparatus 200, for example, comprises a communication unit 202, a communication control unit 230, a throughput measuring unit 210, a communication state prediction unit 220, a communication distinguishing unit 240, a priority level setting unit 250, a quality calculation unit 260, and a speech recognition control unit 276. In the present embodiment, the device 25c, for example, comprises a content executor 282, and a display unit 284.

In the present embodiment, the information processing apparatus 200, the control apparatus 24a, the control apparatus 24b, and the control apparatus 24c are connected to each other via the in-vehicle network 29. The in-vehicle network 29 may include an Ethernet (registered trademark) network. The in-vehicle network 29 may include a CAN (Controller Area Network).

[Outline of Control Apparatus 24 and Device 25]

The control apparatus 24a and the control apparatus 24b control the device 25a and the device 25b, respectively. In the same manner, the control apparatus 24c controls the device 25c. The control apparatus 24a, the control apparatus 24b and the control apparatus 24c each may be an ECU (Electronic Control Unit). The device 25a, the device 25b and the device 25c, for example, include a driveline device, an information communication device or the like. Examples of the driveline device include an engine and a motor.

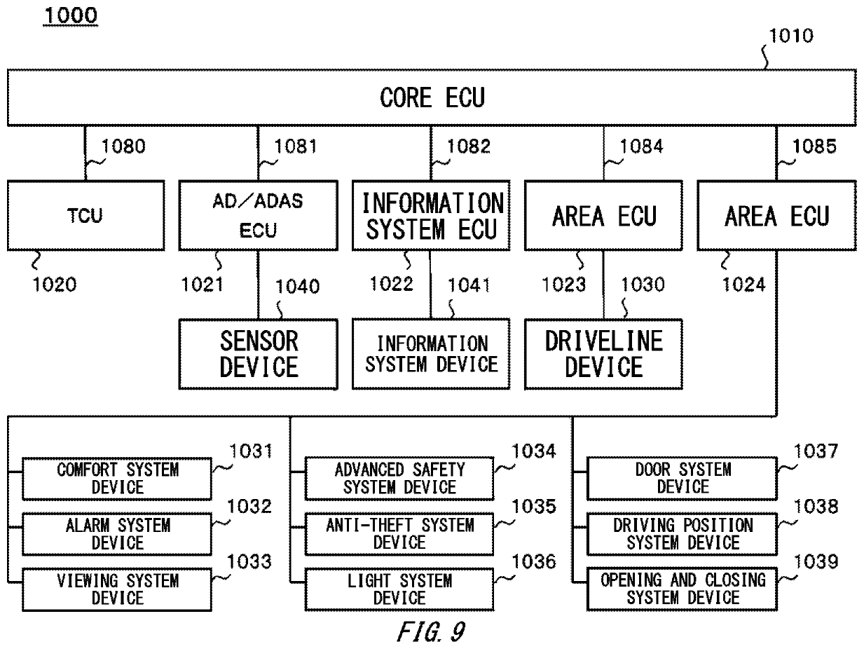

Note that the term “control apparatus 24” may be used as the generic term of the control apparatus 24a and the control apparatus 24b control apparatus 24c. The term “device 25” may be used as the generic term of the device 25a, the device 25b and the device 25c. As for an embodiment of the control apparatus 24 and the device 25, the specific example will be described in connection with FIG. 9 and so on.

In the embodiment described in connection with FIG. 2, a case where the device 25c includes an information system device or an audio visual system device is used as an example to describe an example of the device 25c. In an embodiment, the device 25c presents the executed result of the data 32 that the information processing apparatus 200 has received from the external apparatus 30a to the user. In another embodiment, the device 25c presents the speech recognition result that the information processing apparatus 200 has received from the external apparatus 30c to the user.

In the present embodiment, the content executor 282 acquires the data 32 from the external apparatus 30a. The content executor 282 executes the data 32. As mentioned above, the data 32 is the data of the content that the external apparatus 30a delivers, and videos, speeches and the like are played by executing the data 32. The content executor 282 causes the display unit 284 to display an image (which may be referred to as a content image) that is generated by executing the data 32. The content image may be each of one or more images included in a video content. The content image may be an example of the executed result of the data 32.

In the present embodiment, the display unit 284 displays an image. The image may be a moving image or may be a still image. Examples of the display unit 284 include a display and a projector. The display unit 284 may comprise an input apparatus, such as a touch panel, a pointing device, a switch, a speech recognition system, and a gesture recognition system. The display unit 284 may comprise a speech output apparatus, such as a speaker.

For example, the display unit 284 displays the image that the content executor 282 has output (which may be referred to as played). When the display unit 284 comprises a speech output apparatus, the display unit 284 may output the speech that the content executor 282 has output (which may be referred to as played).

The display unit 284 also executes the speech recognition processing. The display unit 284 (i) acquires the speech of the user and (ii) decides the content of the command or order that the user inputs to the information processing apparatus 200 by the speech. In this manner, the display unit 284 can accept the input by the user.

In an embodiment, the display unit 284 executes the speech recognition processing by utilizing the speech recognition function that the external apparatus 30c provides. In another embodiment, the display unit 284 executes the speech recognition processing without utilizing the speech recognition function that the external apparatus 30c provides. The number of types of the command or order that can handle the case where the display unit 284 executes the speech recognition processing without utilizing the speech recognition function provided by the external apparatus 30c may be less than the number of types of the command or order possible to handle the case where the display unit 284 executes the speech recognition processing by utilizing the speech recognition function provided by the external apparatus 30c.

[Specific Configuration of Each Unit of Control Apparatus 24 and Device 25]

Each unit of the control apparatus 24 may be achieved by hardware or may be achieved by software, or may be achieved by hardware and software. Each unit of the device 25 may be achieved by hardware or may be achieved by software, or may be achieved by hardware and software.

[Outline of Each Unit of Information Processing Apparatus 200]

The communication unit 202 communicates with the external apparatus 30 via the mobile communication network. For example, the communication unit 202 transmits and receives the data 32 to/from the external apparatus 30a in accordance with the instruction from the communication control unit 230. The communication unit 202 transmits and receives the data 34 to/from the external apparatus 30b in accordance with the instruction from the communication control unit 230. The communication unit 202 also transmits and receives the data 36 to/from the external apparatus 30c in accordance with the instruction from the communication control unit 230.

The throughput measuring unit 210 measures the communication throughput for communication with the external apparatus 30. Note that the throughput measuring unit 210 may measure the communication throughput in the uploading direction from the communication unit 202 to the external apparatus 30. The throughput measuring unit 210 may measure the communication throughput in the downloading direction from the external apparatus 30 to the communication unit 202.

The communication state prediction unit 220 predicts the future communication state at least by using a communication throughput that the throughput measuring unit 210 has measured. For example, the communication state prediction unit 220 predicts the future communication throughput. Note that examples of the communication state include a throughput, a delay, and a packet loss.

The communication control unit 230 controls the data communication with the external apparatus 30 on the basis of the future communication state that the communication state prediction unit 220 has predicted. Specifically, the communication control unit 230 controls the data communication with the external apparatus 30 by controlling the communication unit 202. For example, if the future communication state deteriorates compared to a predetermined state, the communication control unit 230 restricts the bandwidth or communication throughput for the data communication of which the priority level set by the priority level setting unit 250 is low, in comparison with the data communication of which the priority level set by the priority level setting unit 250 is high.

In addition, if the future communication state, for example the future communication throughput, satisfies a predetermined condition, the communication control unit 230 controls the data communication with the external apparatus 30a such that the data communication volume related to the data 36 when the speed of the vehicle 50 is a first speed is smaller than the data communication volume related to the data 36 when the speed of the vehicle 50 is a second speed. Note that the second speed may be slower than the first speed. The second speed may be a speed smaller than a predetermined threshold. The second speed may be substantially 0. Examples of the predetermined condition include a condition where the future communication state deteriorates compared to a predetermined state and a condition where the future communication throughput is smaller than a predetermined value.

In this manner, if the vehicle speed of the vehicle 50 is slow enough, the bandwidth or communication throughput assigned to the data communication of the data 36 is relatively large. As a result, the usability related to the speech recognition processing improves.

In an embodiment, when the vehicle speed of the vehicle 50 is the second speed, the data communication volume of the data of the control system is smaller than when the vehicle speed of the vehicle 50 is the first speed. As mentioned above, the second speed can be slower than the first speed.

For example, when the information processing apparatus 200 downloads a map data for navigation, as the vehicle speed of the vehicle 50 increases, the range of the map data to be requested becomes wider. Also, as the vehicle speed of the vehicle 50 increases, the frequency of requesting the map data increases.

In addition, if the vehicle 50 is moving, collecting and transmitting various data can be executed for the purpose of collecting big data. On the other hand, if the vehicle 50 is stopped, said collecting and transmitting of data can be stopped.

For example, the external apparatus 30b generates various maps by utilizing the data uploaded from one or more vehicles 50. The type of the map is not particularly limited. In each map, for each of one or more points, the information showing the location of each point and the various types of information at each point are associated with each other and stored.

More specifically, the external apparatus 30b acquires, from each of one or more vehicles 50, the information obtained by associating the information showing the measuring result of a LiDAR (light detection and ranging) which is equipped in each of one or more vehicles 50 (which may be referred to as LiDAR data) with the information showing the location of the point where said LiDAR data is acquired. The external apparatus 30b may acquire, from each of one or more vehicles 50, the information obtained by associating the image data of a image captured by a camera equipped in each of one or more vehicles 50 with the information showing the location of the point where said image has been captured. The external apparatus 30b stores these pieces of information in any storage apparatus. The external apparatus 30b may execute a cleansing processing on these pieces of information and store the data after the cleansing processing in any storage apparatus. In this manner, for example, the external apparatus 30b can generate a map related to a roadway and/or the shape of the buildings disposed to the vicinity of said roadway in approximately real time.

In this manner, when the LIDAR data or the image data is uploaded from the vehicle 50 to the external apparatus 30b, a request to increase the frequency of uploading the data may be made as the vehicle speed of the vehicle 50 increases. On the other hand, as the vehicle speed of the vehicle 50 decreases, the frequency of uploading the data may decrease, and when the vehicle 50 is stopped, collecting and transmitting said data can be stopped.

As a result, when the vehicle speed of the vehicle 50 is the second speed, when compared to a case where the vehicle speed of the vehicle 50 is the first speed, the proportion that the time of sending and receiving the data 34 between the information processing apparatus 200 and the external apparatus 30b accounts for becomes smaller in a period of time having a predetermined time length (which may be referred to as an unit time period). On the other hand, in the unit time period, the proportion which the time for sending and receiving the data 36 between the information processing apparatus 200 and the external apparatus 30c accounts for becomes larger. In this manner, the data communication volume related to the data 36 when the speed of the vehicle 50 is the first speed can be smaller than the data communication volume related to the data 36 when the speed of the vehicle 50 is the second speed.

In another embodiment, the priority levels of data communications are set such that they are dynamically changed according to the vehicle speed of the vehicle 50. According to said embodiment, for example, when the vehicle speed of the vehicle 50 is the second speed, the priority level of a part of the data of the control system is lower than the priority level of the data 36. As a result, the data communication volume related to the data 36 when the speed of the vehicle 50 is the first speed can be smaller than the data communication volume related to the data 36 when the speed of the vehicle 50 is the second speed.

The communication distinguishing unit 240 distinguishes the type of data communications with the external apparatus 30. The priority level setting unit 250 sets priority levels of communications for a plurality of data communications on the basis of the type which the communication distinguishing unit 240 has distinguished.

The priority level setting unit 250 sets priority levels of communications for a plurality of data communications on the basis of the type which the communication distinguishing unit 240 has distinguished and the quality of the data communication. The priority level setting unit 250 may set priority levels of communications for a plurality of data communication on the basis of the type which the communication distinguishing unit 240 has distinguished and the quality of the data communication that the quality calculation unit 260 has calculated.

The quality calculation unit 260 calculates the quality of the data communication on the basis of the communication throughput that the communication state prediction unit 220 has predicted. For example, the quality calculation unit 260 may calculate multimedia quality (MMq) (for example, the MMq as defined in ITU-T Recommendation G.1070). Note that the quality calculation unit 260 may calculate any index showing the quality of service, other than the multimedia quality, as the quality of the data communication.

In the present embodiment, the speech recognition control unit 276 controls the speech recognition processing by the information processing apparatus 200. For example, the speech recognition control unit 276 outputs a signal for controlling the speech recognition processing by the information processing apparatus 200 to the control apparatus 24c so as to control the speech recognition processing by the device 25c.

Specifically, on the basis of the future communication state that the communication state prediction unit 220 has predicted, the speech recognition control unit 276 decides whether to execute the speech recognition processing utilizing the external apparatus 30c. The speech recognition control unit 276 decides the future state of the speech recognition processing on the basis of the future communication state that the communication state prediction unit 220 has predicted. On the basis of the future communication state that the communication state prediction unit 220 has predicted, the speech recognition control unit 276 decides whether to inform the user of the future state of the speech recognition processing. The speech recognition control unit 276 may output a signal showing these decision results to the control apparatus 24c. The details of the speech recognition control unit 276 will be described below.

Note that as mentioned above, when the communication state prediction unit 220 was able to predict the future communication state, on the basis of said predicted future communication state, the speech recognition control unit 276 may decide the state of the speech recognition processing at a certain future time. The speech recognition control unit 276 may also decide whether to inform the user of the future state of the speech recognition processing. On the other hand, when the communication state prediction unit 220 has failed to predict the future communication state, the speech recognition control unit 276 may decide to inform the user of the fact that the future communication state could not be predicted and/or of the current communication state.

[Outline of Information Processing in Each Unit of Information Processing Apparatus 200]

When the future communication throughput is below a predetermined threshold, the communication control unit 230 restricts the communication throughput for the data communication of which the priority level set by the priority level setting unit 250 is low, compared with the data communication of which the priority level set by the priority level setting unit 250 is high. This can increase the possibility of continuously communicating pieces of data having a high priority level. Note that when the future communication throughput become temporarily below a predetermined threshold, the communication control unit 230 may not restrict the communication throughput for the data communication having a low priority level. For example, when the future communication throughput is below a predetermined threshold for a time period shorter than a predetermined time, the communication control unit 230 may not restrict the communication throughput for the data communication having a low priority level.

When the time during which the future communication throughput is below a predetermined threshold exceeds a predetermined time, the communication control unit 230 may restrict the communication throughput for the data communication having a low priority level. The predetermined threshold may be a variable value. The communication control unit 230 may define the threshold on the basis of the situation of the data communication with the external apparatus 30. For example, the communication control unit 230 may define the threshold on the basis of a communication throughput necessary for providing minimum quality of service in the data communication with external apparatus 30. The communication control unit 230 may define, as the threshold, the value obtained by multiplying the communication throughput necessary for providing said minimum quality of service by a predetermined factor. The predetermined factor may be any value no less than 1. The predetermined factor may be any value no more than 1. Note that the predetermined threshold may be a fixed value instead of a variable value.

The communication control unit 230 restricts the communication throughput by delaying the data communication for the data communication of which the priority level set by the priority level setting unit 250 is low, compared with the data communication of which the priority level set by the priority level setting unit 250 is high. The communication control unit 230 may delay the data communication by buffering the data that is communicated by the data communication having a low priority level. The data at a high priority level is not delayed, and thus it is possible to enhance the possibility of continuously communicating the data having a high priority level. Note that the communication control unit 230 may restrict the communication throughput by decreasing the data amount of the data communication having a low priority level. The communication control unit 230 may restrict the communication throughput by decreasing the bit rate of the data communication having a low priority level. When the data to be transmitted through the data communication having a low priority level is an image data, the communication control unit 230 may restrict the communication throughput by deteriorating the image quality of the image to be transmitted.

The communication state prediction unit 220 may use the amount of delay by which the communication control unit 230 delays the data communication having a low priority level so as to predict the future communication state (for example, the future communication throughput). According to the present embodiment, the communication state prediction unit 220 predicts the future communication state, in consideration of the delay information. In this manner, the prediction accuracy of the future communication state improves.

The communication distinguishing unit 240 distinguishes, as the type of data communication, whether the data communication is related to the controlling of the vehicle 50. The priority level setting unit 250 sets the priority level of a predetermined data communication related to the control of the vehicle 50 higher than the priority levels of other data communications. In this manner, the data communication related to the control of the vehicle 50 can be continuously performed, which thus can enhance the safety of the vehicle 50 driving. When a predetermined value required to continue providing a service based on the data communication related to the control system of the vehicle 50 cannot be secured as the communication throughput of the data communication related to the control system of the vehicle 50, the communication control unit 230 may stop another predetermined data communication. Note that the communication distinguishing unit 240 may distinguish whether the data communication is related to the control of the vehicle 50 or it is the data communication of multimedia, as the type of data communication. The priority level setting unit 250 may set the priority level of the data communication related to the control of the vehicle 50 higher than the priority level of the data communication related to the multimedia.

The communication control unit 230 may restrict the communication throughput of the data communication having a low priority level to a predetermined value necessary for continuing providing the service based on the data communication having a low priority level. In this manner, as for the data communication having a low priority level as well, the possibility that the data communication is completely disconnected can be reduced.

The communication state prediction unit 220 may be an example of a throughput prediction unit. The speech recognition control unit may be an example of a state informing unit. The display unit 284 may be an example of the state informing unit. The display unit 284 may be an example of a first speech recognition unit and a second recognition unit. The speech recognition processing by the first speech recognition unit may be an example of the speech recognition processing in a first speech recognition mode. The speech recognition processing by the second recognition unit may be an example of the speech recognition processing in a second speech recognition mode. The display unit 284 may be an example of a recognition means decision unit. The information processing apparatus 200 and a part thereof may be an example of the information processing apparatus. At least a part of the information processing apparatus 200 and the control apparatus 24c may serve as an example of the information processing apparatus. At least a part of the information processing apparatus 200, the control apparatus 24c, and at least a part of the device 25c may serve as an example of the information processing apparatus.

[Example of Another Embodiment]

In connection with FIG. 2, the details of each functional block which configures the vehicle 50 related to the present embodiment have been described. However, the vehicle 50 is not limited to the present embodiment. In another embodiment, the vehicle 50 may comprise functional blocks other than the functional blocks shown in FIG. 2. Also, the vehicle 50 may not comprise some of the functional blocks shown in FIG. 2. In the same manner, the information processing apparatus 200 may comprise functional blocks other than the functional blocks shown in FIG. 2. The information processing apparatus 200 may comprise at least a part of the control apparatus 24, or may comprise at least a part of the device 25. Also, the information processing apparatus 200 may not comprise some of the functional blocks shown in FIG. 2.

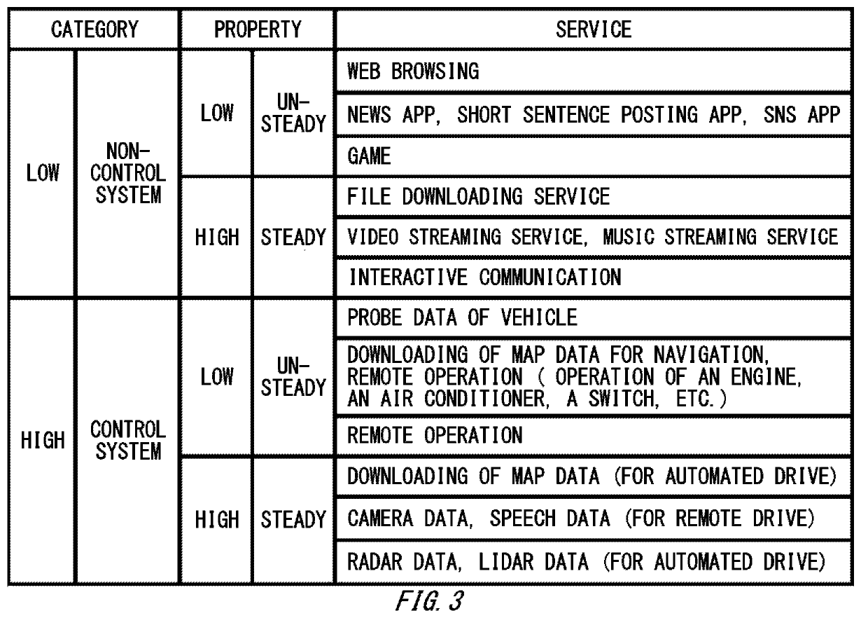

FIG. 3 is a table showing priority levels of data communications. In the table of FIG. 3, the “category” shows whether services are of the control system or non-control system of the vehicle 50. The “property” shows whether the data communication is steady or unsteady. The “service” shows the content of the services provided by the data communication. As shown in FIG. 3, the data communication related to the service for the control system of the vehicle 50 has a higher priority level than the data communication related to the service for the non-control system. Also, the steady data communication has a higher priority level than the unsteady data communication. Note that, in addition to the “category” and the “property” shown in FIG. 3, priority levels can be set for each service.

[Example of Another Embodiment]

In the present embodiment, a case where the priority levels of data communications are fixed is used as an example to describe an example of the priority levels of data communications. However, the priority levels of data communications are not limited to the present embodiment.

In another embodiment, the priority levels of data communications may be dynamically changed. For example, the priority levels of data communications are dynamically changed according to the vehicle speed of the vehicle 50. For example, the information processing apparatus 200 stores a plurality of data tables showing the priority levels of data communications so as to control the data communication on the basis of the priority levels shown by said data tables.

Specifically, the information processing apparatus 200 stores (i) a data table used when the vehicle speed of the vehicle 50 is smaller than a predetermined threshold and (ii) a data table used when the vehicle speed of the vehicle 50 is larger than a predetermined threshold. The information processing apparatus 200 may store (i) a data table used when the vehicle 50 is stopped, (ii) a data table used when the vehicle 50 is not stopped, and the vehicle speed of the vehicle 50 is smaller than a predetermined threshold and (iii) a data table used when the vehicle speed of the vehicle 50 is larger than a predetermined threshold.

In the present embodiment, a case where the priority levels of data communications related to all of the services classified as being of the non-control system are lower than the priority levels of data communications related to all of the services classified as being of the control system has been used as an example to describe an example of the priority levels of data communications. However, the priority levels of data communications are not limited to the present embodiment.

In another embodiment, the priority level of data communication for each service can be set such that the priority levels of data communications related to some of the services classified as being of the non-control system may be higher than the priority levels of data communications related to some of the services classified as being of the control system. For example, when a certain condition is met, the priority level of data communication for each service is set such that the priority levels of data communications related to some of the services classified as being of the non-control system are higher than the priority levels of data communications related to some of the services classified as being of the control system.

Specifically, when the vehicle speed of the vehicle 50 is larger than a predetermined threshold, the priority levels of data communications are set such that the priority levels of data communications related to some of the services classified as being of the non-control system are lower than the priority levels of data communications related to some of the services classified as being of the control system. On the other hand, (i) when the vehicle 50 is stopped, or (ii) when the vehicle speed of the vehicle 50 is smaller than a predetermined threshold, the priority levels of data communications are set such that the priority levels of data communications for downloading, for example, a video content, a speech content, a game content, a SNS content, and a Web content, is higher than the priority levels of data communications for downloading, for example, a map data of a location apart from the current location by a certain distance among map data for navigation.

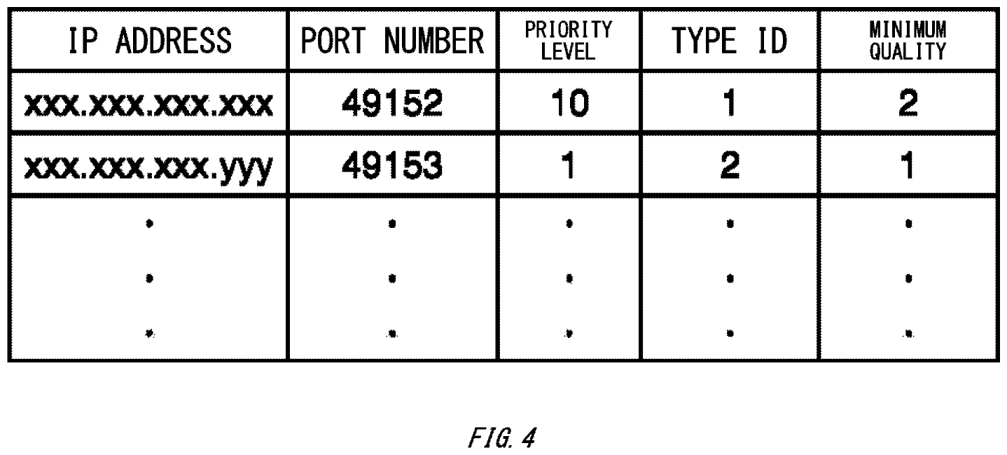

FIG. 4 shows an example of the data structure of data communication information stored in the information processing apparatus 200. The data communication information is obtained by associating an IP address, a port number, a priority level, a type ID, and a minimum quality. The IP address is, for example, an IP address assigned to the control apparatus 24. The port number is a port number used in a transport layer protocol in a TCP/communication. The “priority level” shows a priority level assigned to the data communication that is identified by a combination of the IP address and the port number. The “type ID” shows a type defined by the combination of the IP address and the port number. The “minimum quality” shows a minimum quality of service required to maintain providing the service by the data communication. For example, as an index of the minimum quality, the MMq can be used.

In the present embodiment, the service for the data communication is defined, for example, among the services shown in FIG. 3, by the combination of the IP address and the port number included in a communication packet which is transmitted from the control apparatus 24. The communication control unit 230 identifies the priority level and the type of data communication on the basis of the combination of the IP address and the port number included in the communication packet and the data communication information. Note that when the data communication is a data transmission, the “IP address” is a source IP address and the “port number” is a source port number.

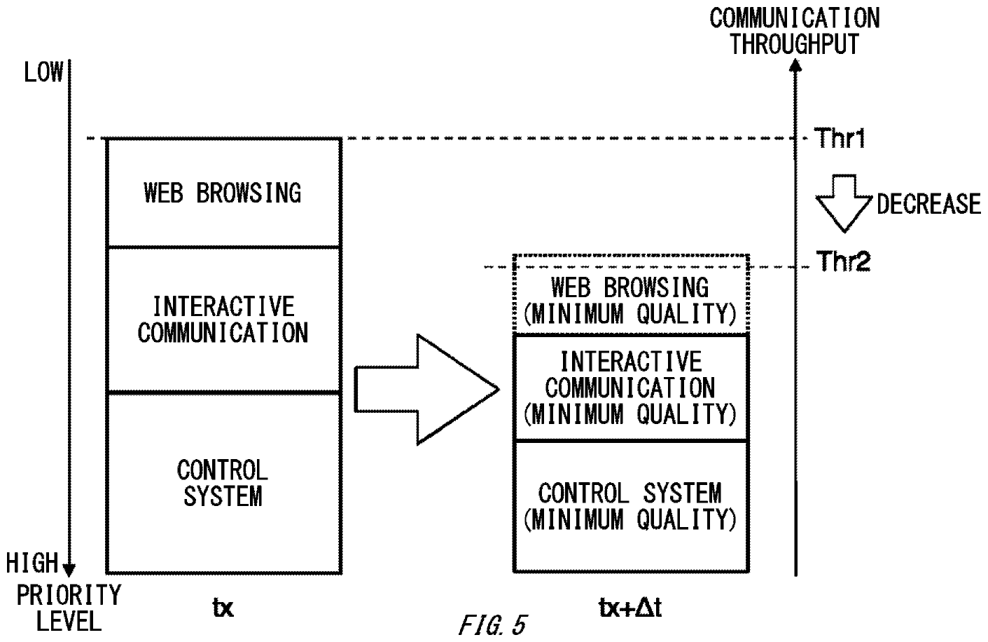

FIG. 5 conceptually shows a control of communication throughput that the communication control unit 230 performs on the basis of the priority level. The data communication of the control system, the interactive communication, and the Web browsing are performed at a time tx. Here, the data communication for the control system has a higher priority level than the data communication for the non-control system (the interactive communication and the Web browsing). Also, among the data communication of the non-control system, the data communication of the interactive communication has a higher priority level than the data communication of the Web browsing.

A total value of the communication throughput at the time tx is Thr1. Assume that the communication throughput after Δt from the time tx has been predicted to decrease to Thr2 by the communication state prediction unit 220. When it is determined that a total value of the communication throughput necessary for providing the minimum quality of service each required for each data communication that is currently performed exceeds Thr2, the communication control unit 230 controls each throughput of the data communication for the control system and the data communication of the interactive communication data to a communication throughput value at which the minimum quality of service can be guaranteed. Also, the communication control unit 230 temporarily stops the data communication of the Web browsing. This makes it possible for the whole communication throughput not to exceed the predicted throughput while maintaining the data communication related to the control system of the vehicle 50.

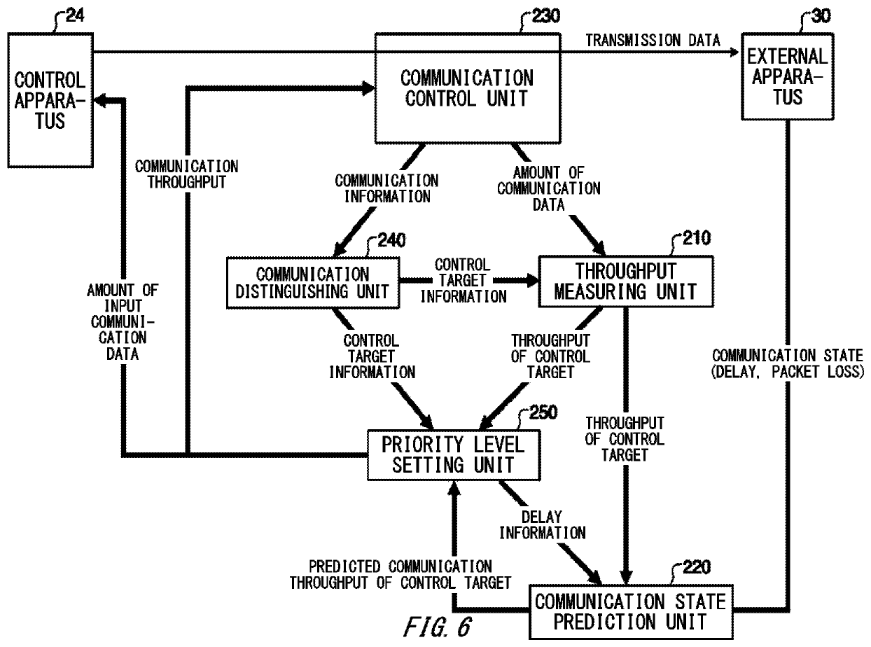

FIG. 6 schematically shows a flow of data between functional blocks of the information processing apparatus 200. In the present embodiment, for the sake of the simple description, a case where the communication state prediction unit 220 predicts the future communication throughput as the future communication state is used as an example to describe the detail flow of the above-described data.

The communication control unit 230 monitors transmission data that is transmitted from the control apparatus 24. The communication control unit 230 determines whether the data communication for a new service is started on the basis of the combination of the IP address and the port number. When the new communication is started, the communication control unit 230 informs the communication distinguishing unit 240 of the communication information including the IP address and the port number. The communication control unit 230 transmits, to the throughput measuring unit 210, the information showing the amount of the data for the communication with the external apparatus 30, in response to a request of the throughput measuring unit 210.

The communication distinguishing unit 240 distinguishes the type of data communications on the basis of communication information. For example, the communication distinguishing unit 240 distinguishes the type of data communications on the basis of the IP address and the port number. The communication distinguishing unit 240 distinguishes the type of data communications on the basis of the data communication information shown in FIG. 4. The communication distinguishing unit 240 informs the throughput measuring unit 210 and the priority level setting unit 250 of the control target information including the type of data communication.

The throughput measuring unit 210 measures the communication throughput between the communication unit 202 and the external apparatus 30. The throughput measuring unit 210 calculates the current communication throughput on the basis of the amount of the communication data informed from the communication control unit 230. The throughput measuring unit 210 may measure the communication throughput for each control target information. The throughput measuring unit 210 may measure the total communication throughput. The throughput measuring unit 210 informs the priority level setting unit 250 and the communication state prediction unit 220 of the measured communication throughput of the control target.

The communication state prediction unit 220 predicts the future communication throughput on the basis of the communication throughput measured by the throughput measuring unit 210. For example, the communication state prediction unit 220 identifies a prediction model of the time series data on the basis of the time series data of the communication throughput. The prediction model to be identified may be any model that can predict future time series data from past time series data. Examples of the prediction model to be identified can include a time series model, such as an AR model (AutoRegressive Model), and a stochastic differential equation model, such as a Vasicek model. As an example, when the Vasicek model is used, a model parameter of a general solution of the stochastic differential equation of the Vasicek model may be identified by using the general solution of the stochastic differential equation of the Vasicek model and the time series data are used, and using a method, such as a maximum likelihood estimation method. The communication state prediction unit 220 calculates a probability distribution of the time series data of the future communication throughput on the basis of the identified prediction model. The communication state prediction unit 220 may predict the future communication throughput on the basis of the probability distribution of the time series data of the future communication throughput. Note that the communication state prediction unit 220 may calculate the probability distribution of the time series data of the future communication throughput by using methods described in above-described Patent Document 1 and above-described Patent Document 2. As described in above-described patent document 1 and above-described patent document 2, the prediction model of the time series data may be identified based on a corrected time series data, which is obtained by calculating a correction factor on the basis of a communication model, which is obtained by modeling a transient characteristic after starting communication for a communication protocol of TCP communication or the like, and using this correction factor for correcting the time series data for removing influence of the transient characteristic.

The communication state prediction unit 220 may predict the communication throughput on the basis of the communication state fed back from the external apparatus 30. The communication state prediction unit 220 may predict the future communication throughput for each control target of the communication throughput. Examples of the communication state fed back from the external apparatus 30 can include a network transfer delay and a packet loss rate. The communication state prediction unit 220 informs the priority level setting unit 250 of the predicted future communication throughput. The communication state prediction unit 220 may calculate the future communication throughput on the basis of the delay information set at the priority level setting unit 250 as described below.

The communication state prediction unit 220 may utilize map information showing each location of one or more areas with a high possibility of having poor communication state in advance so as to predict the future communication state. The map information may associate, for each of one or more areas, the information showing the location of said area with the information showing the communication state at said location or in the area and store them.

In an embodiment, the communication state prediction unit 220 acquires information showing the self-location of the vehicle 50 from the self-location estimating apparatus (not depicted) disposed in the vehicle 50 or the information processing apparatus 200. The communication state prediction unit 220 predicts the future location or area of the vehicle 50 on the basis of the movement history of the vehicle 50 which is shown by the information showing the self-location of the vehicle 50. By comparing the above-described prediction result and the above-described map information, the communication state prediction unit 220 can predict the future communication state.

In another embodiment, the communication state prediction unit 220 acquires information showing the movement path of the vehicle 50 from a path exploration apparatus (not depicted) disposed in the vehicle 50 or the information processing apparatus 200. Also, the communication state prediction unit 220 acquires the information showing the self-location of the vehicle 50 from the self-location estimating apparatus (not depicted) disposed in the vehicle 50 or the information processing apparatus 200. The communication state prediction unit 220 predicts the future location or area of the vehicle 50 on the basis of the information showing the self-location of the vehicle 50 and the information showing the movement path of the vehicle 50. By comparing the above-described prediction result and the above-described map information, the communication state prediction unit 220 can predict the future communication state.

The priority level setting unit 250 sets priority levels for each data communication to decide the communication throughput of each data communication. Based on the control target information for each type of the data communication informed from the communication distinguishing unit 240; the type of data communication of the control target informed from the communication distinguishing unit 240; and the predicted communication throughput informed from the communication state prediction unit 220, the priority level setting unit 250 sets the priority level for each type of the data communication and, according to the priority level, sets the communication throughput. The priority level setting unit 250 may set the amount of delay of the data communication such that the set communication throughput can be obtained. The priority level setting unit 250 may inform the communication state prediction unit 220 of the set amount of delay of the data communication.

Note that the quality calculation unit 260 may calculate an index value of the quality of service on the basis of the future communication throughput. The index value of the communication quality may be the MMq. The priority level setting unit 250 may calculate the communication throughput on the basis of the quality of service that the quality calculation unit 260 has calculated. For example, the priority level setting unit 250 may refer to associated information obtained by associating a predetermined index value of the communication quality with the communication throughput so as to select the communication throughput associated with the index value lower than or equal to the communication quality that the quality calculation unit 260 has calculated. The priority level setting unit 250 may set the communication throughput, for the data communication having a priority level higher than a predetermined value, corresponding to the quality of service higher than or equal to the minimum quality, and also set the communication throughput, for the data communication having a priority level lower than the predetermined value, corresponding to the quality of service being minimum quality, for adaptation to the future communication throughput.

The priority level setting unit 250 informs the communication control unit 230 of the set communication throughput. The communication control unit 230 delays the transmission data for each type of the data communication in accordance with the communication throughput for each type of the data communication informed from the priority level setting unit 250. Also, the priority level setting unit 250 informs the control apparatus 24 of an amount of input communication data per unit time corresponding to the set communication throughput. The control apparatus 24 restricts the transmission of the transmission data for each type of the data communication in accordance with the amount of input communication data informed from the priority level setting unit 250. For example, the control apparatus 24 restricts an data amount that is transmitted to the external apparatus 30 for each service defined by the port number. This makes it possible to appropriately restrict the communication throughput according to the priority level of the data communication.

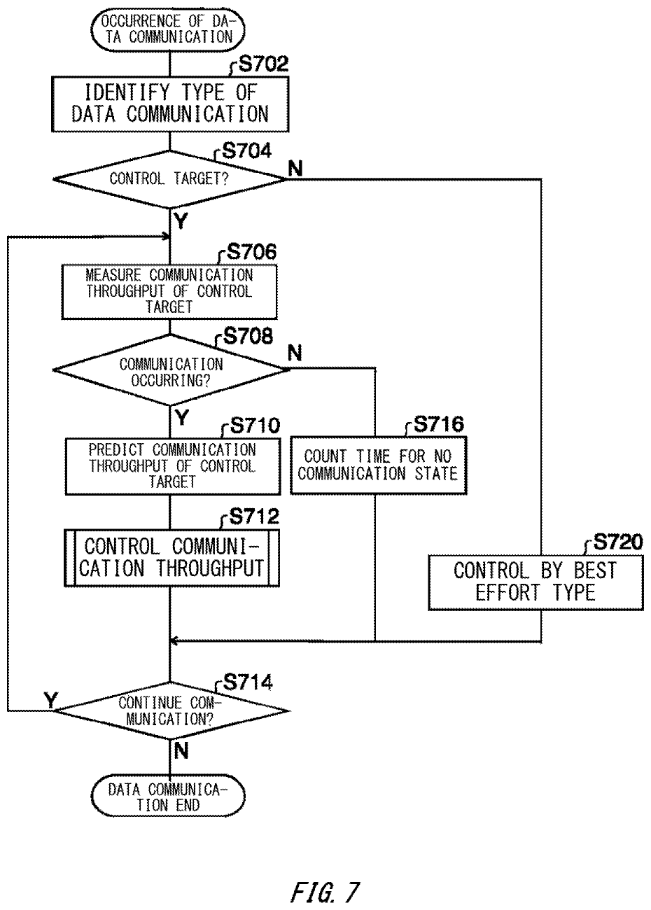

FIG. 7 shows a flowchart related to an information processing method executed by the information processing apparatus 200. Processing of this flowchart is started when an occurrence of the communication with the external apparatus 30 has been detected by the communication control unit 230.

In S702, the communication distinguishing unit 240 identifies the type of the data communication that has occurred. For example, the communication distinguishing unit 240 identifies the type of the data communication that has occurred on the basis of the IP address and the port number. In S704, the communication distinguishing unit 240 determines whether the data communication that has occurred is the control target of the communication throughput. When the data communication that has occurred is not the control target of the communication throughput, the communication control unit 230 decides a best effort type control scheme as a control scheme of the data communication that has occurred in S720, and the processing proceeds to S714. When the data communication that has occurred is the control target of the communication throughput, the throughput measuring unit 210 measures the communication throughput of the control target in S706. In S708, the throughput measuring unit 210 determines whether the communication is occurring.

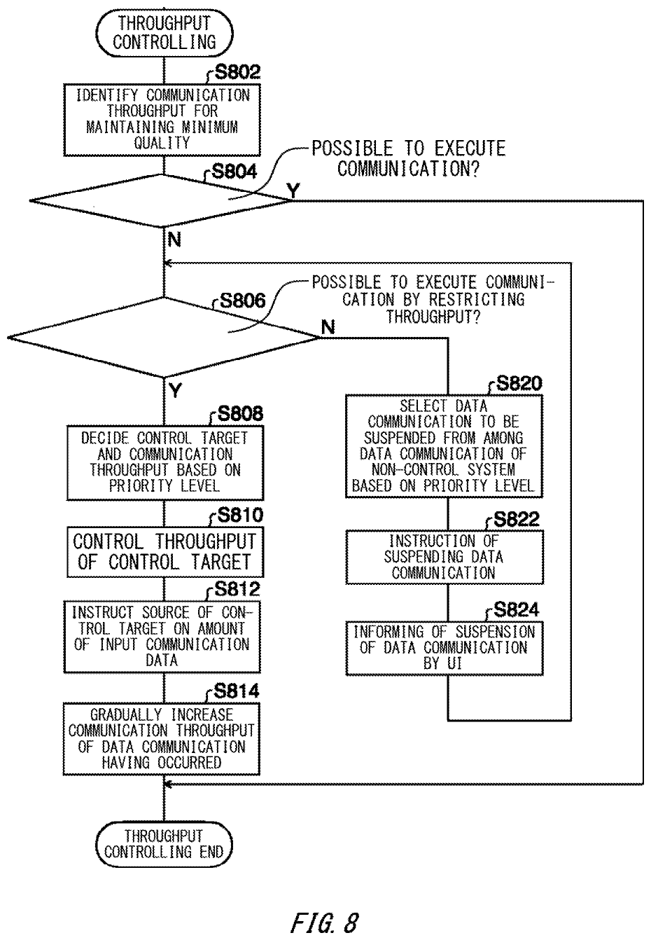

When it is determined that communication is not occurring in S708, the throughput measuring unit 210 counts a time during which communication is not occurring in S716, and the processing proceeds to S714. For example, the throughput measuring unit 210 counts an elapsed time from a timing when it is determined that no communication has occurred. When it is determined that the communication is occurring in S708, the communication state prediction unit 220 predicts the future throughput of the control target of the communication throughput (S710). In S712, the communication control unit 230 controls the communication throughput, and the processing proceeds to S714. Note that the processing of S712 will be described in connection with FIG. 8 and the like.

In S714, the communication control unit 230 determines whether to continue the data communication. When the time during which communication is not occurring, which is counted by the throughput measuring unit 210, exceeds a predetermined value, the communication control unit 230 determines that the data communication is not continued. Also, when receiving information for disconnecting the communication from the control apparatus 24, the communication control unit 230 determines that the data communication is not continued. When it is determined that the data communication is continued in S714, the processing proceeds to S706. When it is determined that the data communication is not continued in S714, the data communication ends.

FIG. 8 shows a flowchart related to a control method for the communication throughput executed by the information processing apparatus 200. Processing of this flowchart can be applied to the processing of S712.

In S802, the priority level setting unit 250 identifies the communication throughput (minimum throughput) required to secure the minimum quality of service for the data communication that is the control target of the communication throughput. For example, the priority level setting unit 250 identifies the minimum throughput for the data communication that is the control target of the communication throughput on the basis of quality information of the data communication information.

In S804, the priority level setting unit 250 determines whether the data communication can be performed, on the basis of the future communication throughput that the communication state prediction unit 220 has predicted. The priority level setting unit 250 determines whether the predicted quality of service which is calculated by the quality calculation unit 260 is higher than or equal to the minimum quality defined by the data communication information. When the data communication can be performed, the processing of this flowchart ends.

When it is determined that the data communication can be executed, the priority level setting unit 250 determines whether the data communication becomes executable by restricting the communication throughput of the data communication at a low priority level in S806. When it is determined that the data communication becomes executable by restricting the communication throughput of the data communication at a low priority level, the data communication of the control target of the communication throughput and the communication throughput are decided on the basis of the priority level, in S808. In S810, the communication control unit 230 restricts the communication throughput of the data communication of the control target. In S812, the priority level setting unit 250 instructs the control apparatus 24, which performs the data communication of the control target, on the amount of input communication data. In S814, the communication control unit 230 gradually increases the communication throughput of the data communication toward the minimum throughput so as to end the processing of this flowchart.

When it is determined that the data communication does not become executable by restricting the communication throughput in S806, the priority level setting unit 250 selects the data communication to be suspended from the data communications for the non-control system in which the data communication is currently occurring on the basis of the priority level in S820. For example, the priority level setting unit 250 selects the data communication to be suspended in ascending order of priority level. In S822, the priority level setting unit 250 instructs the control apparatus 24 that performs the selected data communication to suspend the selected data communication. In S824, the control apparatus 24 informs the occupant of the vehicle 50 that the data communication is temporarily suspended through a user interface, and the processing proceeds to S806.

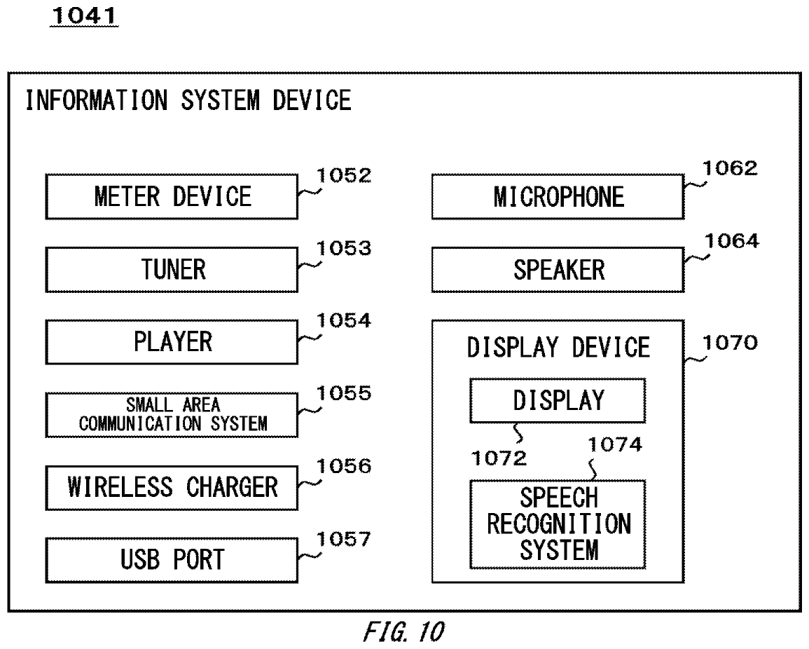

FIG. 9 and FIG. 10 are used for describing the details of an example implementation of the control system. FIG. 9 shows the example implementation of the control system 1000 of the vehicle 50. FIG. 10 schematically shows an example of the internal configuration of an information system device 1041.

As shown in FIG. 9, in the present embodiment, the control system 1000 comprises core ECU 1010. In the present embodiment, the control system 1000 comprises a TCU 1020, an AD/ADAS ECU 1021, a information system ECU 1022, an area ECU 1023, and an area ECU 1024.

In the present embodiment, the control system 1000 comprises a driveline device 1030, a comfort system device 1031, a viewing system device 1033, an alarm system device 1032, an advanced safety system device 1034, an anti-theft system device 1035, a light system device 1036, a door system device 1037, a driving position system device 1038, an opening and closing system device 1039, a sensor device 1040, and an information system device 1041. In the present embodiment, the control system 1000 comprises a communication network 1080, a communication network 1081, a communication network 1082, a communication network 1084, and a communication network 1085.

Examples of the driveline device 1030 include an electric parking brake (EPB), an electric power steering (EPS) system, a vehicle stability assist (VSA) system, a shifter (SHIFTER), a power drive unit (PDU), an intelligent power unit (IPU), and a fuel injection (FI) apparatus. Examples of the sensor device 1040 include a camera, a radar, a sensor including the LIDAR. Examples of the information system device 1041 include an information communication device, a multimedia-related device, and an user interface device.

As shown in FIG. 10, in the present embodiment, the information system device 1041 comprises a meter device 1052, a tuner 1053, a player 1054, a small area communication system 1055, a wireless charger 1056, a USB port 1057, a microphone 1062, a speaker 1064, and a display device 1070. In the present embodiment, the display device 1070 has a display 1072 and a speech recognition system 1074.

The core ECU 1010 controls the whole vehicle 50. The core ECU 1010 controls the whole vehicle 50 by controlling the TCU 1020, the AD/ADAS ECU 1021, the information system ECU 1022, the area ECU 1023, and the area ECU 1024.

The TCU 1020 is a telematics control unit. The AD/ADAS ECU 1021 is an ECU that performs a control related to the automated drive (AD) and advanced driver assistance systems (ADAS). The AD/ADAS ECU 1021 is connected to each sensor that the sensor device 1040 comprises through a bus so as to control each sensor that the sensor device 1040 comprises while acquiring information detected by each sensor. The information system ECU 1022 is connected to each device that the information system device 1041 comprises through the bus so as to control each device that the information system device 1041 comprises.

The area ECU 1023 is connected to each device that the driveline device 1030 comprises through the bus so as to control each device in the driveline device 1030 comprises. The area ECU 1024 is connected, through the bus, to the comfort system device 1031, the alarm system device 1032, the viewing system device 1033, the advanced safety system device 1034, the anti-theft system device 1035, the light system device 1036, the door system device 1037, the driving position system device 1038 and the opening and closing system device 1039, to control devices comprised by the comfort system device 1031, the alarm system device 1032, the viewing system device 1033, the advanced safety system device 1034, the anti-theft system device 1035, the light system device 1036, the door system device 1037, the driving position system device 1038 and the opening and closing system device 1039.

The display device 1070 displays an image in the display 1072. The display device 1070 may execute the data 32 to generate a content image and display said content image in the display 1072. If a communication failure in the future is predicted, the display device 1070 may display a replaced image in the display 1072 instead of the content image. The display device 1070 may display information showing the possibility of the communication failure in the future in the display 1072.

The display device 1070 may be an example of the display unit 284.

The speech recognition system 1074 executes the speech recognition processing. For example, the speech recognition system 1074 analyzes the speech of the user to estimate the content of the command or order from the user. The speech recognition system 1074 executes the command or order on the basis of said analyzed result. Note that the display device 1070 may comprise an input apparatus, such as a touch panel, a pointing device and a switch, instead of the speech recognition system 1074 or with the speech recognition system 1074.

The communication network 1080, the communication network 1081, the communication network 1082, the communication network 1084, and the communication network 1085 are each an example implementation of the in-vehicle network 29. The communication network 1080, the communication network 1081, the communication network 1082, the communication network 1084, and the communication network 1085 may comprise the Ethernet (registered trademark) network. The TCU 1020, the core ECU 1010, the AD/ADAS ECU 1021, the information system ECU 1022, the area ECU 1023, and the area ECU 1024 may be capable of IP communications via the communication network 1080, the communication network 1081, the communication network 1082, the communication network 1084, and the communication network 1085. Note that the communication network 1084 and the communication network 1085 may comprise the CAN.

The TCU 1020 may be an example of the above-mentioned information processing apparatus 200. Note that the TCU 1020 and the core ECU 1010 may cooperate with each other to function as the above-mentioned information processing apparatus 200. The AD/ADAS ECU 1021, the information system ECU 1022, the area ECU 1023, and the area ECU 1024 may each be an implementation example of the above-mentioned control apparatus 24.

The driveline device 1030, the sensor device 1040, the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039 may each be an example of devices of the control system of the vehicle 50. The information system device 1041 may be an example a device of the non-control system.

The data communication related to the device included in the sensor device 1040, the driveline device 1030, the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039, may have a lower priority level than the data communication related to the device included in the information system device 1041.

Note that the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039 may include an auxiliary machine of the vehicle 50. The comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039 may each be an example of the auxiliary machine of the vehicle 50.

The priority level of the data communication related to the auxiliary machine of the vehicle 50 may be set lower than the priority level of the data communication related to other devices. Among the auxiliary machines of the vehicle 50, the priority level of the data communication related to the auxiliary machines other than the auxiliary machine included in the advanced safety system device 1034 may set lower than the priority level of the data communication related to another device. The priority level of the data communication related to the auxiliary machine included in the advanced safety system device 1034 may be set higher than the priority level of the data communication related to the auxiliary machine included in the comfort system device 1031, the alarm system device 1032, the viewing system device 1033, the anti-theft system device 1035, the light system device 1036, the door system device 1037, the driving position system device 1038, and the opening and closing system device 1039.

As mentioned above, the vehicle 50 may be an example of the mobile object. The example of the mobile object includes a transport device, such as a motor vehicle, such as a passenger car and a bus, a saddle riding type vehicle, an aircraft and a marine vessel. The mobile object is not limited to the transport device, and may be any movable device.

As described above, with the information processing apparatus 200 and an example implementation of the information processing apparatus 200, it is possible to enhance a possibility of enabling the data communication at a high priority level to continue, by restricting the data communication at a low priority level. Typically, when the plurality of data communications are performed in a device equipped in the mobile object, it is required to communicate in a communication speed (also referred to as a communication band). However, it is not always possible to obtain an appropriate communication speed in all of the plurality of data communications. For example, when the communication speed has decreased due to the deterioration of the communication environment, there is a problem that the data communication at a high priority level may be restricted. In contrast, with the above-mentioned information processing apparatus 200, such a problem can be mitigated.

The core ECU 1010 may be an example of the information processing apparatus. The core ECU 1010 may be an example of the state informing unit. The TCU 1020 may be an example of the information processing apparatus. The TCU 1020 may be an example of the throughput measuring unit. The TCU 1020 may be an example of the communication state prediction unit. The TCU 1020 may be an example of the state informing unit. The control apparatus 24c may be an example of the state informing unit. The device 25c may be an example of the state informing unit. The speaker 1064 may be an example of the state informing unit. The display device 1070 may be an example of the informing unit.

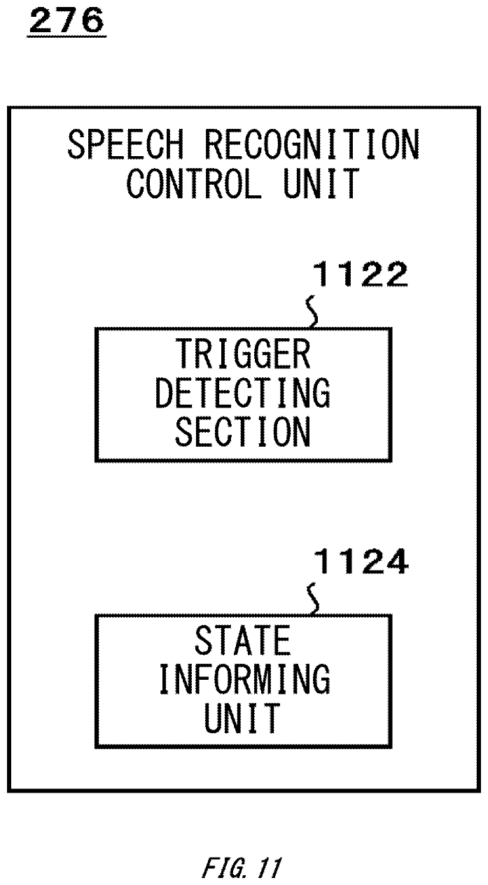

FIG. 11 schematically shows an example of the internal configuration of the speech recognition control unit 276. In the present embodiment, the speech recognition control unit 276 comprises a trigger detecting section 1122 and a state informing unit 1124.

In the present embodiment, the trigger detecting section 1122 detects trigger information which shows that the user wishes to start the speech recognition processing. As mentioned above, examples of the trigger information include a Wake-Up keyword being uttered, a starting button of the speech recognition processing being pushed, and an icon in which a start command of the speech recognition processing is embedded being selected.

In an embodiment, the speech recognition control unit 276 acquires a speech data of the user via the microphone 1062 and analyzes said speech data to detect trigger information. In another embodiment, the speech recognition control unit 276 may receive a signal showing that the trigger information is detected from the speech recognition system 1074.

In the present embodiment, when said trigger detecting section has detected said trigger information, the state informing unit 1124 decides whether to inform the user of the state of the speech recognition processing on the basis of the future communication state that the communication state prediction unit 220 has predicted. When the state informing unit 1124 has decided to inform the user of the state of the speech recognition processing, the state informing unit 1124 may output a signal showing that the user is informed of the state of the speech recognition processing to the control apparatus 24c.

In this manner, the user is informed of the state of the speech recognition processing on the basis of the future communication state that the communication state prediction unit 220 has predicted. Note that when the state informing unit 1124 has decided not to inform the user of the state of the speech recognition processing, the state informing unit 1124 may not output the signal showing that the user is informed of the state of the speech recognition processing to the control apparatus 24c, or may output a signal showing that the user is not informed of the state of the speech recognition processing to the control apparatus 24c.

The state informing unit 1124 may decide the time when a speech recognition processing (which may be referred to as an online speech recognition function) that utilizes the speech recognition function provided by the external apparatus 30c becomes possible on the basis of the future communication state that the communication state prediction unit 220 has predicted. The state informing unit 1124 may decide to inform the user of the time when the speech recognition processing that utilizes the speech recognition function provided by the external apparatus 30c becomes possible as the state of the speech recognition processing. The state informing unit 1124 may output a signal showing the above-described decision result to the control apparatus 24c.

As mentioned above, for example, there can be a case where the communication state prediction unit 220 cannot predict the future communication state depending on the communication environment of the vehicle 50. Therefore, when the communication state prediction unit 220 was able to predict the future communication state, the state informing unit 1124 may execute the above-mentioned various decision processing and signal output processing. On the other hand, when the communication state prediction unit 220 has failed to predict the future communication state, the state informing unit 1124 may decide to inform the user of (i) the fact that the communication state prediction unit 220 has failed to predict the future communication state and/or (ii) of the current communication state. Also, the state informing unit 1124 may output the signal showing the above-described decision result to the control apparatus 24c.

(i) When the communication state prediction unit 220 has predicted that the future communication state deteriorates compared to a predetermined first state, or (ii) when the current communication state is worse than a predetermined second state, the state informing unit 1124 may decide to inform the user that the speech recognition processing is executed without utilizing the speech recognition function provided by the external apparatus 30c, as the state of the speech recognition processing. The first state and the second state may be substantially identical states, or may be different states. The first state may be a state having a better communication state than the second state, or may be a state having a poorer communication state than the second state.

The second state is decided, for example, based on (i) the frequency or probability at which the communication state prediction unit 220 cannot predict the future communication state, or (ii) the prediction accuracy of the future communication state by the communication state prediction unit 220. In an embodiment, the communication state in which the frequency or probability at which the communication state prediction unit 220 cannot predict the future communication state is larger than a predetermined value can be defined as the communication state in the second state. In another embodiment, the communication state in which the prediction accuracy of the future communication state by the communication state prediction unit 220 is smaller than a predetermined value can be defined as the communication state in the second state.

For example, when the speech recognition system 1074 has a function of executing a speech recognition offline (which may be referred to as an offline speech recognition function), the state informing unit 1124 decides to inform the user that the speech recognition processing is executed utilizing the offline speech recognition function as the state of the speech recognition processing. The state informing unit 1124 may output a signal showing the above-described decision result to the control apparatus 24c.

(i) When the communication state prediction unit 220 has predicted that the future communication state deteriorates compared to the predetermined first state or (ii) when the current communication state is worse than the predetermined second state, the state informing unit 1124 may decide to inform the user of at least some of one or more commands available by the use of the offline speech recognition function as the state of the speech recognition processing. The state informing unit 1124 may output a signal showing the above-described decision result to the control apparatus 24c.

(i) When the communication state prediction unit 220 has predicted that the future communication state deteriorates compared to the predetermined first state, or (ii) when the current communication state is worse than the predetermined second state, (i) if the speech recognition system 1074 does not have the offline speech recognition function, or (ii) if the user has instructed to input the command unavailable by the use of the offline speech recognition function, the state informing unit 1124 may decide to inform the user of (i) the fact that the input of the command by the user cannot be accepted and (ii) the time when the speech recognition processing that utilizes the first speech recognition function becomes possible, as the state of the speech recognition processing. The state informing unit 1124 may output a signal showing the above-described decision result to the control apparatus 24c.

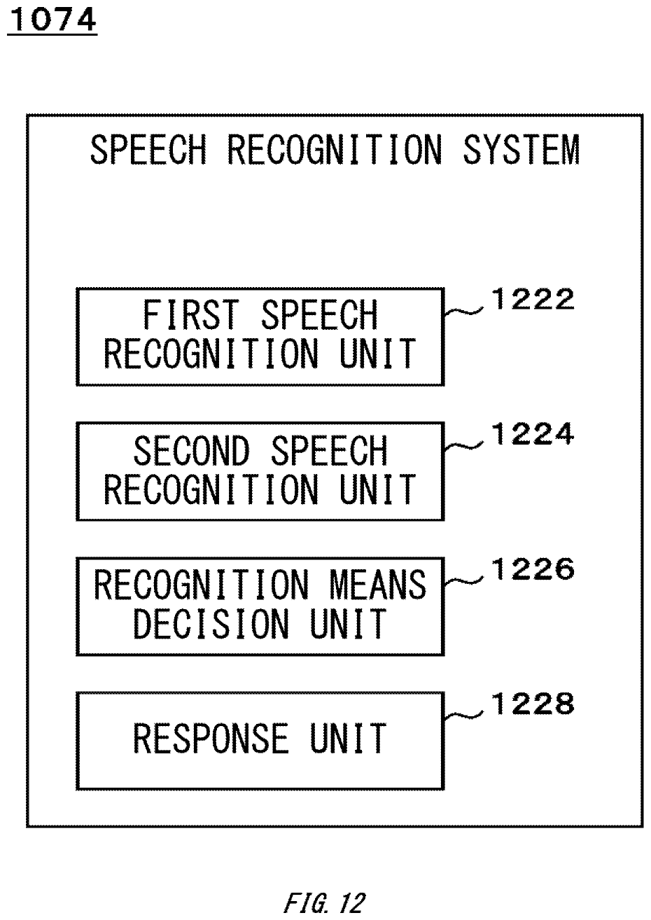

FIG. 12 schematically shows an example of the internal configuration of the speech recognition system 1074. In the present embodiment, the speech recognition system 1074 comprises a first speech recognition unit 1222, a second recognition unit 1224, a recognition means decision unit 1226 and a response unit 1228.

In the present embodiment, the first speech recognition unit 1222 executes the speech recognition processing utilizing the speech recognition function that the external apparatus 30c provides. The first speech recognition unit 1222 provides the above-mentioned online speech recognition function.

In the present embodiment, the second recognition unit 1224 executes the speech recognition processing without utilizing the speech recognition function that the external apparatus 30c provides. The second recognition unit 1224 provides the above-mentioned offline speech recognition function.

In the present embodiment, the recognition means decision unit 1226 decides whether to use the first speech recognition unit 1222 or the second recognition unit 1224 to execute the speech recognition processing on the basis of the future communication state that the communication state prediction unit 220 has predicted. The recognition means decision unit 1226 may decide whether to use the first speech recognition unit 1222 or the second recognition unit 1224 to execute the speech recognition processing on the basis of the current communication state. As mentioned above, for example, the current communication state is measured by the throughput measuring unit 210.

For example, (i) when the communication state prediction unit 220 has predicted that the future communication state deteriorates compared to the predetermined first state or (ii) when the current communication state is worse than the predetermined second state, the recognition means decision unit 1226 decides to execute the speech recognition processing using the second recognition unit 1224. The first state and the second state may be substantially identical states or may be different states. The first state may be a state having a better communication state than the second state, or may a state having a poorer communication state than the second state.

When the communication state prediction unit 220 has predicted that the future communication state does not deteriorate compared to predetermined first state, the recognition means decision unit 1226 may decide to execute the speech recognition processing using the first speech recognition unit 1222. When the communication state prediction unit 220 has predicted that the future communication state is better than the predetermined first state, the recognition means decision unit 1226 may decide to execute the speech recognition processing using the first speech recognition unit 1222.

When the recognition means decision unit 1226 has decided to execute the speech recognition processing using the second recognition unit 1224, and subsequently when the communication state has been recovered and/or when the communication state is expected to be recovered, the recognition means decision unit 1226 may decide whether to execute the speech recognition processing by the first speech recognition unit 1222 in addition to the speech recognition processing by the second recognition unit 1224. When there is information that could not be acquired in the speech recognition processing by the second recognition unit 1224 or a command or order which the speech recognition processing by the second recognition unit 1224 could not handle, the recognition means decision unit 1226 may decide to execute the speech recognition processing by the first speech recognition unit 1222.

In the present embodiment, the response unit 1228 responds to the utterance or instruction of the user. For example, the response unit 1228 acquires information showing the result of the speech recognition processing from at least one of the first speech recognition unit 1222 or the second recognition unit 1224. In this manner, the response unit 1228 can acquire the information showing the command or order instructed by the user. The response unit 1228 executes the above-described command or order. The response unit 1228 may inform the user of the information showing the executed result of the command or order.

In an embodiment, the response unit 1228 outputs the information showing the above-described executed result in the display 1072 to inform the user of said information. In another embodiment, the response unit 1228 outputs the information showing the above-described executed result from 1064 to inform the user of said information.

The response unit 1228 may be an example of the state informing unit.

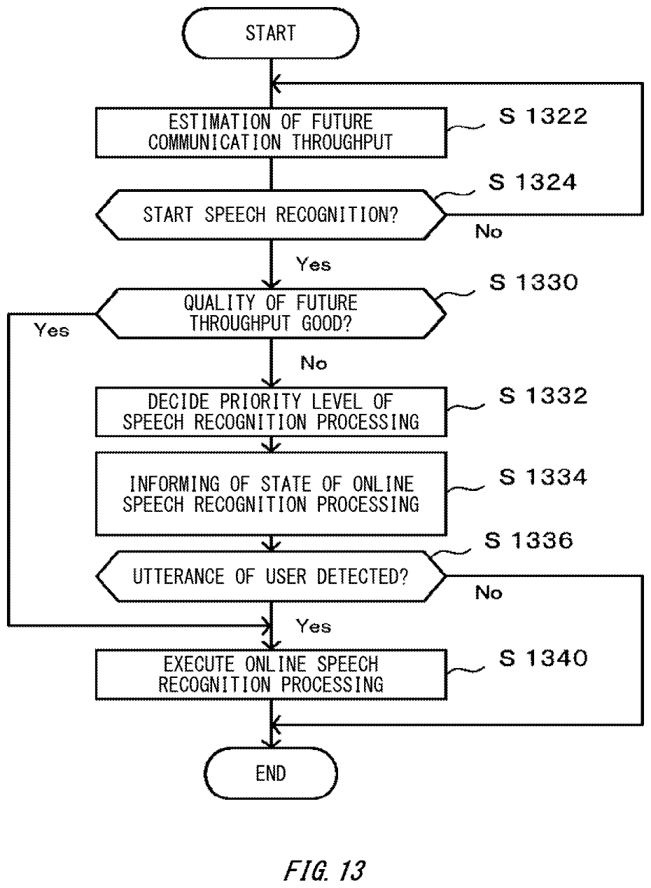

FIG. 13 schematically shows an example of the information processing by the vehicle 50. According to the present embodiment, first, in step 1322 (where the step may be abbreviated to S), the communication state prediction unit 220 predicts the future communication state. In the present embodiment, for the sake of the simple description, a case where the communication state prediction unit 220 predicts the future communication throughput (which may be referred to as the future throughput) as the future communication state is used as an example to describe an example of the information processing by the vehicle 50.

Next, in S1324, whether the information processing apparatus 200 starts the speech recognition processing is decided. For example, when the trigger detecting section 1122 has detected the trigger information, it is decided that the information processing apparatus 200 starts the speech recognition processing. On the other hand, when the trigger detecting section 1122 has not detected the trigger information, it is decided that the information processing apparatus 200 does not start the speech recognition processing.

When it is decided that the information processing apparatus 200 does not start the speech recognition processing (when it is No in S1324), the processing of S1322 is repeated. On the other hand, when it is decided that the information processing apparatus 200 starts the speech recognition processing (when it is Yes in S1324), whether the quality of the future throughput is good is determined in S1330. For example, the priority level setting unit 250 determines whether the quality of the future throughput is good on the basis of the prediction result of the communication state prediction unit 220.

In S1330, when it is determined that the quality of the future throughput is not good (when it No in S1330), in S1332, the priority level setting unit 250 decides the priority level of the data communication related to the speech recognition processing. In this manner, the bandwidth assigned to the data communication related to the speech recognition processing (that is, the data communication related to data 36), the communication throughput of the data communication related to the speech recognition processing and the like are decided.

Next, in S1334, the state informing unit 1124 decides the state of the speech processing of the speech recognition system 1074. For example, the state informing unit 1124 decides whether it is possible to utilize the online speech recognition function on the basis of the priority level of the data communication related to the speech recognition processing decided in S1332. Based on the priority level of the data communication related to the above-described speech recognition processing and the like, the state informing unit 1124 may estimate the response time in the case of utilizing the online speech recognition function. In this manner, the state of the speech processing of the speech recognition system 1074 is decided. Also, the state informing unit 1124 decides to inform the user of the state of the speech processing of the speech recognition system 1074.

The state informing unit 1124 may decide the method of informing the user of the state of the speech processing of the speech recognition system 1074. Examples of the above-described informing method include an output of a speech from the speaker 1064 and an output of a message or icon to the display 1072.

Next, in S1336, whether the utterance of the user has been detected is determined. For example, the speech recognition system 1074 analyzes the speech of the user, where the sounds are collected by the microphone 1062, to execute a detection processing of the utterance of the user. When the utterance of the user has not been detected (when it is No in S1336), the processing ends. On the other hand, in S1336, when the utterance of the user has been detected, an online speech recognition processing is executed in S1340. Specifically, the recognition means decision unit 1226 decides to execute the speech recognition processing by using the first speech recognition unit 1222. Also, the first speech recognition unit 1222 utilizes the speech recognition function that the external apparatus 30c provides to execute the speech recognition processing. When the speech recognition processing ends, the processing ends.

On the other hand, in S1330, when it is determined that the quality of the future throughput is good (when it is Yes in S1330), in the above-mentioned procedure, the online speech recognition processing is executed in S1340. When the speech recognition processing ends, the processing ends.

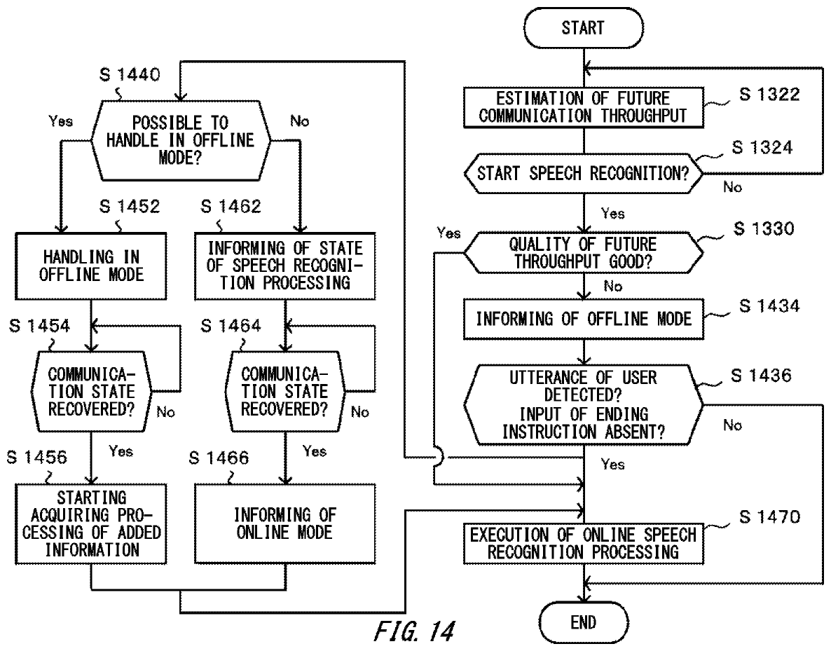

FIG. 14 schematically shows an example of the information processing by the vehicle 50. According to the present embodiment, first, in a procedure same with the procedure described in connection with FIG. 13, S1322, S1324 and S1330 are executed.

In S1330, when it is determined that the quality of the future throughput is poor (when it is No in S1330), the state informing unit 1124 decides the state of the speech processing of the speech recognition system 1074 in S1434. For example, the state informing unit 1124 decides whether it is possible to utilize the online speech recognition function on the basis of the priority level of the data communication related to the speech recognition processing decided in S1332 and the like. Based on the above-described priority level of the data communication related to the speech recognition processing, the state informing unit 1124 may estimate the response time in the case of utilizing the online speech recognition function. In this manner, the state of the speech processing of the speech recognition system 1074 is decided.

Also, the state informing unit 1124 decides to inform the user of the state of the speech processing of the speech recognition system 1074. According to the present embodiment, because the quality of the future throughput is poor, the speech recognition system 1074 cannot utilize the online speech recognition function, and it is informed that the speech recognition system 1074 responds to the user by utilizing the offline speech recognition function.

Next, in S1436, it is determined (i) whether the utterance of the user has been detected, and (ii) whether the ending instruction of the user has been accepted. For example, the speech recognition system 1074 analyzes the speech of the user, where the sounds are collected by the microphone 1062, to execute the detection processing of the utterance of the user. When the utterance of the user has not been detected (when it is No in S1436), the processing ends. For example, the user can input the instruction to end the speech recognition processing by operating a touch panel, switch or the like. The user may input the above-described instruction by the speech. When the instruction to end the speech recognition processing has been accepted (when it is No in S1436), the processing ends.

On the other hand, in S1436, when the utterance of the user has been detected, in S1440, for example, the recognition means decision unit 1226 determines, to the instruction of the user, whether it is possible to handle said instruction by utilizing the offline speech function (which may be referred to as an offline mode). When it is possible to handle it the offline mode (when it is Yes in S1440), the offline speech recognition processing is executed in S1452. Specifically, the recognition means decision unit 1226 decides to execute the speech recognition processing by using the second recognition unit 1224. Also, the second recognition unit 1224 executes the speech recognition processing without utilizing the speech recognition function that the external apparatus 30c provides.

Also, in S1454, it is determined whether the communication state has been recovered. When it is not determined that the communication state has been recovered (when it is No in S1454), the processing of S1454 is repeated. On the other hand, in S1454, when it is determined that the communication state has been recovered (when it is Yes in S1454), in S1456, the recognition means decision unit 1226 executes the online speech recognition processing to decide whether to acquire additional information (which may be referred to as added information), and whether to execute an additional command or order. When the recognition means decision unit 1226 has decided to execute the online speech recognition processing, an online speech processing is executed in S1470.

In S1470, specifically, the recognition means decision unit 1226 decides to execute the speech recognition processing by using the first speech recognition unit 1222. Also, the first speech recognition unit 1222 executes the speech recognition processing by utilizing the speech recognition function that the external apparatus 30c provides. When the speech recognition processing ends, the processing ends.

On the other hand, in S1440, when it is impossible to handle it in the offline mode (when it is No in S1440), the state informing unit 1124 decides to inform the user of the state of the speech processing of the speech recognition system 1074 in S1462. For example, the state informing unit 1124 decides to inform the user that the command or order instructed by the user is the command or order which is impossible to handle it in offline mode. Also, the state informing unit 1124 may decide to inform the user that it is impossible to utilize the online speech recognition function. The state informing unit 1124 may decide to inform the user of the predicted time when utilization of the online speech recognition function can be resumed.

Also, in S1464, it is determined whether the communication state has been recovered. When it is not determined that the communication state has been recovered (when it is No in S1464), the processing of S1464 is repeated. On the other hand, in S1464, when it is determined that the communication state has been recovered and/or when the communication state is expected to be recovered (when it is Yes in S1464), the state informing unit 1124 decides to inform the user that the online speech recognition processing has become available in S1466. For example, when it is predicted that the future communication state of the communication state prediction unit 220 would be better than a predetermined state, it can be determined that the communication state is expected to be recovered. Subsequently, in S1470, the online speech processing is executed.

On the other hand, in S1330, when it is determined that the quality of the future throughput is good (when it is Yes in S1330), in S1470, the online speech recognition processing is executed in the above-mentioned procedure. When the speech recognition processing ends, the processing ends.

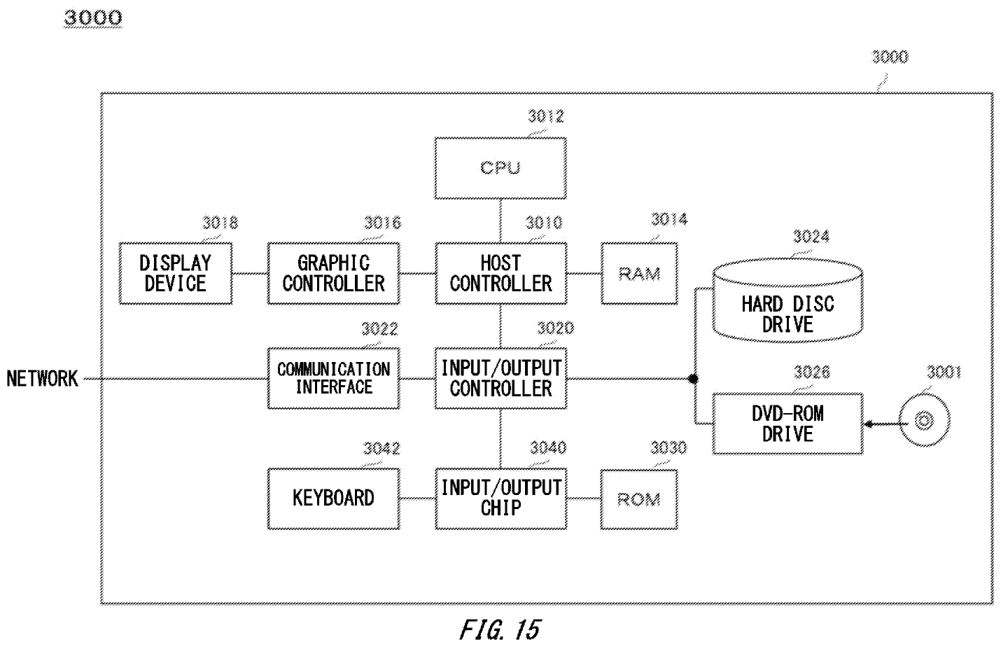

FIG. 15 shows an example of a computer 3000 in which a plurality of embodiments of the present invention can be entirely or partially embodied. For example, at least part of the information processing apparatus 200 is achieved by the computer 3000 or the processor of the computer 3000. For example, at least part of the control apparatus 24 is achieved by the computer 3000 or the processor of the computer 3000. For example, at least part of the device 25 is achieved by the computer 3000 or the processor of the computer 3000. For example, at least part of the content executor 282 is achieved by the computer 3000 or the processor of the computer 3000. For example, at least part of the display unit 284 is achieved by the computer 3000 or the processor of the computer 3000. For example, at least part of the display device 1070 is achieved by the computer 3000 or the processor of the computer 3000.

A program installed in the computer 3000 can cause the computer 3000 to serve as an operation linked with the apparatus according to the embodiment of the present invention or one or more “units” of said apparatus, or can execute said operation or said one or more “units”, and/or can cause the computer 3000 to execute a process according to the embodiment of the present invention or a stage of said process. Such programs may be executed by a CPU 3012 to cause the computer 3000 to execute certain operations linked with some or all of the blocks in the flowcharts and block diagrams described in the present specification. The CPU 3012 may be an example of a processor.

The computer 3000 according to the present embodiment includes the CPU 3012, a RAM 3014, a GPU 3016, and a display device 3018, which are interconnected by a host controller 3010. The computer 3000 also includes input/output units such as a communication interface 3022, a hard disk drive 3024, a DVD-ROM drive 3026, and an IC card drive, which are connected to the host controller 3010 via an input/output controller 3020. The computer also includes legacy input/output units such as a ROM 3030 and a keyboard 3042, which are connected to the input/output controller 3020 via an input/output chip 3040.

The CPU 3012 operates according to programs stored in the ROM 3030 and the RAM 3014, thereby controlling each unit. The GPU 3016 acquires image data generated by the CPU 3012 in a frame buffer or the like provided in the RAM 3014 or in itself, such that the image data is displayed on the display device 3018.

The communication interface 3022 communicates with other electronic devices via a network. The hard disk drive 3024 stores programs and data used by the CPU 3012 in the computer 3000. The DVD-ROM drive 3026 reads the program or data from the DVD-ROM 3001 and provides the programs or data to the hard disk drive 3024 via the RAM 3014. The IC card drive reads the programs and data from an IC card and/or writes the programs and data to an IC card.

The ROM 3030 stores therein a boot program, or the like, executed by the computer 3000 at the time of activation and/or a program dependent on hardware of the computer 3000. The input/output chip 3040 may also connect various input/output units to the input/output controller 3020 via a parallel port, a serial port, a keyboard port, a mouse port, or the like.

The program is provided by a computer-readable storage medium such as a DVD-ROM 3001 or an IC card. The program is read from a computer-readable storage medium, installed in the hard disk drive 3024, the RAM 3014, or the ROM 3030, which also examples of the computer-readable storage medium, and executed by the CPU 3012. The information processing described in these programs is read by the computer 3000 and provides the cooperation between the programs and above-described various types of hardware resources. The apparatus or method may be configured by achieving the operation or processing of information in accordance with the use of the computer 3000.

For example, when communication is executed between the computer 3000 and an external device, the CPU 3012 may execute a communication program loaded in the RAM 3014 and order the communication interface 3022 to perform communication processing on the basis of the processing described in the communication program. Under the control of the CPU 3012, the communication interface 3022 reads transmission data stored in a transmission buffer area provided in a recording medium such as the RAM 3014, the hard disk drive 3024, the DVD-ROM 3001 or the IC card, and transmits the read transmission data to the network, or writes reception data received from the network in a reception buffer area or the like provided on the recording medium.

In addition, the CPU 3012 may cause the RAM 3014 to read all or a necessary part of a file or database stored in an external recording medium such as the hard disk drive 3024, the DVD-ROM drive 3026 (DVD-ROM 3001), the IC card, or the like, and may execute various types of processing on data on the RAM 3014. Next, the CPU 3012 may write back the processed data to the external recording medium.

Various types of information such as various types of programs, data, tables, and databases may be stored in a recording medium and subjected to information processing. The CPU 3012 may execute various types of processing, on the data read from the RAM 3014, including various types of operations, information processing, conditional determination, conditional branch, unconditional branch, information retrieval/replacement, and the like, which are described throughout the present disclosure and designated by a order sequence of a program, and write back the results to the RAM 3014. Also, the CPU 3012 may retrieve information in a file, a database, or the like in the recording medium. For example, when a plurality of entries each having the attribute value of a first attribute linked with the attribute value of a second attribute are stored in the recording medium, the CPU 3012 may retrieve an entry matching the condition in which the attribute value of the first attribute is designated from among said plurality of entries, and read the attribute value of the second attribute stored in said entry, and thereby acquire the attribute value of the second attribute linked with the first attribute satisfying the predetermined condition.

The programs or software modules described above may be stored in a computer-readable storage medium on the computer 3000 or in the vicinity of the computer 3000. Also, a recording medium such as a hard disk or a RAM provided in a server system connected to a dedicated communication network or the Internet can be used as a computer-readable storage medium, thereby providing the above-described program to the computer 3000 via the network.

While the embodiments have been used to describe the present invention, the technical scope of the present invention is not limited to the above-described embodiments. It is apparent to those skilled in the art that various alterations or improvements can be added to the above-described embodiments. It is also apparent from the scope of the claims that the embodiments added with such alterations or improvements can be included in the technical scope of the present invention.

The operations, procedures, steps, and stages of each processing performed by an apparatus, system, program, and method shown in the claims, embodiments, or diagrams can be performed in any order as long as the order is not indicated by “prior to,” “before,” or the like and as long as the output from previous processing is not used in a later processing. Even if the process flow is described using phrases such as “first” or “next” in the claims, embodiments, or diagrams, it does not necessarily mean that the process must be performed in this order.

### EXPLANATION OF REFERENCES

24: control apparatus
25: device
29: in-vehicle network
30: external apparatus
32: data
34: data
36: data
50: vehicle
90: communication network
92: wireless communication system
200: information processing apparatus
202: communication unit
210: throughput measuring unit
220: communication state prediction unit
230: communication control unit
240: communication distinguishing unit
250: priority level setting unit
260: quality calculation unit
276: speech recognition control unit
282: content executor
284: display unit
1000: control system
1010: core ECU
1020: TCU
1021: AD/ADAS ECU
1022: information system ECU
1023: area ECU
1024: area ECU
1030: driveline device
1031: comfort system device
1032: alarm system device
1033: viewing system device
1034: advanced safety system device
1035: anti-theft system device
1036: light system device
1037: door system device
1038: driving position system device
1039: opening and closing system device
1040: sensor device
1041: information system device
1052: meter device
1053: tuner
1054: player
1055: small area communication system
1056: wireless charger
1057: USB port
1062: microphone
1064: speaker
1070: display device
1072: display
1074: speech recognition system
1080: communication network
1081: communication network
1082: communication network
1084: communication network
1085: communication network
1122: trigger detecting section
1124: state informing unit
1222: first speech recognition unit
1224: second recognition unit
1226: recognition means decision unit
1228: response unit
3000: computer
3001: DVD-ROM
3010: host controller
3012: CPU
3014: RAM
3016: GPU
3018: display device
3020: input/output controller
3022: communication interface
3024: hard disk drive
3026: DVD-ROM drive
3030: ROM
3040: input/output chip
3042: keyboard

What is claimed is:

1. An information processing apparatus configured to utilize a first speech recognition function provided by an external speech recognizer via a communication network to execute a speech recognition processing,
wherein a processor is configured to:
detect trigger information, which shows that a user wishes to start the speech recognition processing;
predict a future communication state; and
inform the user of a state of the speech recognition processing based on the predicted future communication state when the trigger information is detected.

2. The information processing apparatus according to claim 1,
wherein the communication state is a bandwidth or throughput.

3. The information processing apparatus according to claim 1,
wherein the processor is further configured to:
(a) when the future communication state is predicted, (i) decide a time when the speech recognition processing utilizing the first speech recognition function becomes possible based on the predicted future communication state, and (ii) inform the user of, as the state of the speech recognition processing, the time when the speech recognition processing utilizing the first speech recognition function becomes possible; and/or
(b) when the future communication state is not predicted, inform the user of (i) the fact that the future communication state is not predicted, and/or (ii) a current communication state.

4. The information processing apparatus according to claim 1,
wherein the processor is further configured to:
control data communication of the information processing apparatus and an external apparatus via a communication network;
distinguish a type of the data communication; and
set a priority level of communication regarding a plurality of the data communications based on the distinguished type,
wherein controlling the data communication includes:
deciding a priority level of data communication with the external speech recognizer based on the predicted future communication state and the set priority level of the communication; and
delaying data communication having a poorer priority level than the data communication with the external speech recognizer, or restricting a bandwidth of the data communication having a poorer priority level.

5. The information processing apparatus according to claim 1,
wherein the processor is further configured to be able to execute:
a first speech recognition mode, where the speech recognition processing is executed by utilizing the first speech recognition function provided by the external speech recognizer; and
a second speech recognition mode, where the speech recognition processing is executed without utilizing the first speech recognition function provided by the external speech recognizer,
wherein the processor is further configured to decide whether to use the first speech recognition mode or the second speech recognition mode to execute the speech recognition processing based on the predicted future communication state.

6. The information processing apparatus according to claim 5,
wherein the processor is configured to decide to execute the speech recognition processing by using the second speech recognition mode (i) when the future communication state is predicted to deteriorate compared to a predetermined first state, or (ii) when a current communication state is poorer than a predetermined second state.

7. The information processing apparatus according to claim 5,
wherein the processor is further configured to inform the user that the speech recognition processing is executed by using the second speech recognition mode, as the state of the speech recognition processing, (i) when the future communication state is predicted to deteriorate compared to a predetermined first state, or (ii) when a current communication state is poorer than a predetermined second state.

8. The information processing apparatus according to claim 5,
wherein the processor is further configured to inform the user of at least some of one or more commands available by using the second speech recognition mode, as the state of the speech recognition processing, (i) when the future communication state is predicted to deteriorate compared to a predetermined first state, or (ii) when a current communication state is poorer than a predetermined second state.

9. The information processing apparatus according to claim 5,
wherein the processor is further configured to:
(i) when the future communication state is predicted to deteriorate compared to a predetermined first state, or (ii) when a current communication state is poorer than a predetermined second state, if the user has instructed to input a command unavailable by using the second speech recognition mode,
inform the user of, as the state of the speech recognition processing, the fact that the input of the command by the user cannot be accepted, and a time when the speech recognition processing utilizing the first speech recognition function becomes possible.

10. The information processing apparatus according to claim 2,
wherein the processor is further configured to:
(a) when the future communication state is predicted, (i) decide a time when the speech recognition processing utilizing the first speech recognition function becomes possible based on the predicted future communication state, and (ii) inform the user of, as the state of the speech recognition processing, the time when the speech recognition processing utilizing the first speech recognition function becomes possible; and/or
(b) when the future communication state is not predicted, inform the user of (i) the fact that the future communication state is not predicted, and/or (ii) a current communication state.

11. The information processing apparatus according to claim 2,
wherein the processor is further configured to:
control data communication of the information processing apparatus and a external apparatus via a communication network;
distinguish a type of the data communication; and
set a priority level of communication regarding a plurality of the data communications based on the distinguished type,
wherein controlling the data communication includes:
deciding a priority level of data communication with the external speech recognizer based on the predicted future communication state and the set priority level of the communication; and
delaying data communication having a poorer priority level than the data communication with the external speech recognizer, or restricting a bandwidth of the data communication having a poorer priority level.

12. The information processing apparatus according to claim 2,
wherein the processor is further configured to be able to execute:
a first speech recognition mode, where the speech recognition processing is executed by utilizing the first speech recognition function provided by the external speech recognizer; and
a second speech recognition mode, where the speech recognition processing is executed without utilizing the first speech recognition function provided by the external speech recognizer,
wherein the processor is further configured to decide whether to use the first speech recognition mode or the second speech recognition mode to execute the speech recognition processing based on the predicted future communication state.

13. A mobile object comprising the information processing apparatus according to claim 1.

14. A non-transitory computer-readable recording medium having recorded thereon a program for causing a computer to execute an information processing method for executing a speech recognition processing by utilizing a first speech recognition function provided by an external speech recognizer via a communication network,
the information processing method comprising:
detecting trigger information showing that a user wishes to start the speech recognition processing;
predicting a future communication state; and
informing the user of a state of the speech recognition processing based on the predicted future communication state in the predicting when the trigger information is detected in the detecting.

15. A information processing method for executing a speech recognition processing by utilizing a first speech recognition function provided by an external speech recognizer via a communication network, the information processing method comprising:
detecting trigger information showing that a user wishes to start the speech recognition processing;
predicting a future communication state; and
informing the user of a state of the speech recognition processing based on the predicted future communication state in the predicting when the trigger information is detected in the detecting.

16. The information processing method according to claim 15,
the informing includes:
(a) when the future communication state is predicted in the predicting, (i) deciding a time when the speech recognition processing utilizing the first speech recognition function becomes possible based on the future communication state predicted in the predicting, and (ii) informing the user of, as the state of the speech recognition processing, the time when the speech recognition processing utilizing the first speech recognition function becomes possible; and/or
(b) when the future communication state is not predicted in the predicting, informing the user of (i) the fact that the future communication state is not predicted in the predicting, and/or (ii) a current communication state.

17. The information processing method according to claim 15, the method further comprising:
controlling data communication with an external apparatus via a communication network;
distinguishing a type of the data communication; and
setting a priority level of communication regarding a plurality of the data communications based on the distinguished type in the distinguishing,
wherein the controlling includes:
deciding a priority level of data communication with the external speech recognizer based on the future communication state predicted in the predicting and the priority level of the communication set in the setting; and
delaying data communication having a poorer priority level than the data communication with the external speech recognizer, or restricting a bandwidth of the data communication having a poorer priority level.

18. The information processing method according to claim 15, the method further comprising:
a first speech recognizing of executing the speech recognition processing by utilizing the first speech recognition function provided by the external speech recognizer;
a second speech recognizing of executing the speech recognition processing without utilizing the first speech recognition function provided by the external speech recognizer, and
deciding recognition means of deciding whether the speech recognition processing is executed by the first speech recognizing or the second speech recognizing based on the future communication state predicted in the predicting.

19. The information processing method according to claim 18,
the deciding recognition means includes:
deciding to execute the speech recognition processing by the second speech recognizing (i) when the future communication state is predicted to deteriorate compared to a predetermined first state in the predicting, or (ii) when a current communication state is poorer than a predetermined second state.

20. The information processing method according to claim 18,
the informing includes:
informing the user that the speech recognition processing is executed by the second speech recognizing, as the state of the speech recognition processing (i) when the future communication state is predicted to deteriorate compared to a predetermined first state in the predicting, or (ii) when a current communication state is poorer than a predetermined second state.
